(19) United States
(12) Patent Application Publication
(10) Pub. No.: US 2026/0220186 A1
(43) Pub. Date: Jul. 30, 2026

(54) PROCESS ONTOLOGY CHANGE MANAGEMENT

(71) Applicant: International Business Machines Corporation, Armonk, NY (US)

(72) Inventors: Tushar Agrawal, West Fargo, ND (US); Carolina Garcia Delgado, Zapopan (MX); Vinod Anandram Valecha, Pune (IN); Sarbajit Kumar Rakshit, Kolkata (IN)

(21) Appl. No.: 19/037,243

(22) Filed: Jan. 26, 2025

(51) Int. Cl. G06F 16/36; G06F 16/23; G06F 16/28; G06Q 10/067

(52) U.S. Cl. CPC G06F 16/367; G06F 16/2358; G06F 16/282; G06Q 10/067

(57) ABSTRACT

Updating subsets of a process ontology includes receiving ontology data of the process ontology and receiving operation data of an execution of an operation. The process ontology includes a hierarchal structure of a plurality of entities and the ontology data indicates a set of operations for each entity of one or more entities of the plurality of entities. Based on the ontology data and the operation data, change data associated with the operation is determined. Based on the change data, subsets of the hierarchal structure are identified. Based on the change data and the ontology data, each of the subsets is updated. The updated subsets of the hierarchal structure are output.

### BACKGROUND

The disclosure relates to the field of business process ontologies, and more particularly, to managing changes in business process ontologies.

A process ontology represents semantic data associated with various aspects of a business. Each piece of semantic data may represent knowledge as a set of concepts within a domain of the business. Moreover, the process ontology represents relationships between the set of concepts within the domain. For example, the semantic data of the process ontology may be processed to model one or more domains of the business. The semantic data may also be used to support the generation of additional semantic data and reasoning of a set of concepts for each of the one or more domains.

### SUMMARY

According to an embodiment of the disclosure, a computer-implemented method for updating subsets of a process ontology is described. The computer-implemented method includes receiving, by a computer, ontology data associated with the process ontology. The process ontology includes a hierarchal structure of a plurality of entities. Further, the ontology data indicates a set of operations associated with each entity of one or more entities of the plurality of entities. The computer-implemented method further includes receiving, by the computer, operation data associated with an execution of at least one operation of the set of operations. The computer-implemented method further includes determining, by the computer, change data associated with the at least one operation of the set of operations based on the ontology data and the operation data. The computer-implemented method further includes identifying, by the computer, one or more subsets of the hierarchal structure based on the change data. The one or more subsets include a first subset associated with the at least one operation and at least one second subset associated with the first subset. The computer-implemented method further includes updating, by the computer, each subset of the one or more subsets of the hierarchal structure based on the change data and the ontology data. Further, the computer-implemented method includes outputting, by the computer, the updated one or more subsets of the hierarchal structure.

According to an embodiment of the disclosure, a computer system for updating subsets of a business ontology is described. The computer system includes a processor set, one or more computer-readable storage media, and program instructions stored on the one or more computer-readable storage media. The program instructions executable by the processor set to cause the processor set to receive ontology data associated with the business ontology. The business ontology includes a hierarchal structure of a plurality of domains. The ontology data indicates a set of operations associated with each domain of one or more domains of the plurality of domains. The program instructions further cause the processor set to receive update data associated with an execution of at least one operation of the set of operations. The program instructions further cause the processor set to generate operation data associated with an execution of at least one operation of the set of operations. The program instructions further cause the processor set to determine change data associated with the at least one operation of the set of operations based on the ontology data and the operation data. The program instructions further cause the processor set to identify one or more sub-ontologies of the business ontology within the hierarchical structure based on the change data. The one or more sub-ontologies include a first sub-ontology associated with the at least one operation and at least one second sub-ontology associated with the first sub-ontology. The program instructions further cause the processor set to update each sub-ontology of the one or more sub-ontologies within the hierarchal structure based on the change data and the ontology data. Further, the program instructions cause the processor set to output the updated one or more sub-ontologies within the hierarchal structure.

According to an embodiment of the disclosure, a computer-program product for updating subsets of a process ontology is described. The computer-program product includes one or more computer-readable storage media and program instructions stored on the one or more computer-readable storage media to perform operations including receiving ontology data associated with the process ontology. The process ontology includes a hierarchal structure of a plurality of entities. The ontology data indicates a set of operations associated with each entity of one or more entities of the plurality of entities. The operations include receiving operation data associated with an execution of at least one operation of the set of operations. The operations include determining change data associated with the at least one operation of the set of operations based on the ontology data and the operation data. The operations include identifying the one or more subsets of the hierarchal structure based on the change data. The one or more subsets include a first subset associated with the at least one operation and at least one second subset associated with the first subset. The operations further include updating each subset of the one or more subsets of the hierarchal structure based on the change data and the ontology data. Further, the operations include outputting the updated one or more subsets of the hierarchal structure.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for updating one or more subsets of a process ontology, in accordance with an embodiment of the disclosure;

FIG. 2 is a diagram that illustrates a network environment for updating the one or more subsets of the process ontology, in accordance with an embodiment of the disclosure;

FIG. 3A is a diagram that illustrates exemplary operations for updating the process ontology, in accordance with an embodiment of the disclosure;

FIG. 3B is a diagram that illustrates exemplary operations for the transmission of notification data, in accordance with an embodiment of the disclosure;

FIG. 3C is a diagram that illustrates exemplary operations for updating one or more subsets of the process ontology, in accordance with an embodiment of the disclosure;

FIG. 4 is a diagram that illustrates an exemplary process ontology, in accordance with an embodiment of the disclosure;

FIG. 5 is a diagram that illustrates exemplary operations for updating sub-ontologies of the process ontology, in accordance with an embodiment of the disclosure;

FIG. 6A is a diagram that illustrates exemplary operations for controlling an execution of at least one operation based on an update in an application, in accordance with an embodiment of the disclosure;

FIG. 6B is a diagram that illustrates exemplary operations for updating the one or more subsets of the process ontology, in accordance with an embodiment of the disclosure;

FIG. 7 is a diagram that illustrates exemplary operations for rendering virtual data, in accordance with an embodiment of the disclosure;

FIG. 8 is a diagram that illustrates exemplary operations for updating a hierarchical structure of the process ontology, in accordance with an embodiment of the disclosure; and

FIG. 9 is a diagram that illustrates a flowchart for an exemplary method for updating the one or more subsets of the process ontology, in accordance with an embodiment of the disclosure.

### DETAILED DESCRIPTION

Across various industries, different types of process ontologies are established and maintained. A process ontology defines a hierarchal structure of semantic data associated with one or more business processes of a business. In particular, the process ontology may identify a set of concepts and relationships associated with the set of concepts within each domain of one or more domains of the business. The process ontology plays a crucial role in organizing and preserving knowledge associated with the one or more domains within the business. The process ontology may also provide a standardized framework for the formalization of rules and procedures associated with the business. Examples of businesses for which a process ontology may be generated may include, but are not limited to, healthcare industry, finance industry, software industry, and manufacturing industry.

The semantic data representing the set of concepts for each of the one or more domains of the business may be retrieved as part of, for example, industry standards and regulations, published articles and research papers, interviews with subject matter experts, business process documents, workflows, user stories, and use cases. The semantic data may be analyzed to identify the set of concepts and the relationships in each of the one or more domains to develop a hierarchal structure for the process ontology.

The hierarchal structure of the process ontology corresponds to a tree-like structure, with a few high-level concepts near a root node of the tree and more specific concepts branching out thereof. For example, a healthcare ontology may include a set of concepts relating to, but not limited to, patients, healthcare providers, medical conditions (that may include more specific concepts, such as cardiology, oncology, dermatology, neurology, endocrinology, and so forth), and insurance records. Such a hierarchal structure developed based on the analysis of the knowledge or the set of concepts of each of the one or more domains may serve as a foundation of the ontology development process. Further, the hierarchal structure tailored for the healthcare industry will have different concepts, relationships, and properties than the hierarchal structure designed for the finance industry.

However, as the business develops and expands, certain changes arise in the business processes. These changes may arise due to, for example, the addition of a new business process, the update of an existing business process, or the deletion of an existing business process. For example, various entities or components of a business work together to perform various activities within a predefined workflow. Such different entities or components may perform certain business processes that may be defined by the predefined workflow. Over time, the entities or components may be enhanced with new or updated functionalities that may not have been previously anticipated under the predefined workflow. Such advancements may require modifications to the workflow to integrate the new or updated functionalities in the business processes. For example, a workflow to be updated is associated with a domain of the business. Subsequently, the workflow is represented as a part, such as a sub-hierarchy of a process ontology of the business. To this end, the process ontology of the business may have to be updated to maintain updated workflows or processes of the business.

Due to the evolving nature of business processes, there is a need to dynamically adapt the process ontology or the hierarchical structure of the process ontology based on any change in the business processes. The dynamic update in the process ontology may align the process ontology with any change in the business. In addition, the update in the process ontology may create a requirement for updating one or more business applications or business tools for performing different operations associated with the business processes. For example, if a healthcare ontology of a healthcare business is updated whereby a new process is added for verification of healthcare providers, then a sub-ontology associated with the healthcare provider may have to be updated. Subsequently, a software application of the healthcare business associated with handling information of the healthcare provider may also have to be updated for executing the new process for the verification of the healthcare.

The present disclosure describes a computer system, a computer-implemented method, and a computer-program product for managing the process ontology of a business. The system of the present disclosure identifies a change in a hierarchal structure of the process ontology of the business and updates the process ontology, thereby ensuring that meaningful information associated with any change in the business processes is delivered to people associated with the business in a timely manner. In addition, the dynamic and automated update or adaption of the process ontology due to any change also ensures subsequent adaption or update of application functionalities associated with one or more software applications of the business processes. The automated update of the process ontology enables faster decision-making in a business environment owing to reduced time and effort for identifying, analyzing, and executing the change manually.

In various embodiments of the disclosure, a computer-implemented method for updating subsets of a process ontology is described. The computer-implemented method includes receiving, by a computer, ontology data associated with the process ontology. The process ontology includes a hierarchal structure of a plurality of entities. Further, the ontology data indicates a set of operations associated with each entity of one or more entities of the plurality of entities. The computer-implemented method further includes receiving, by the computer, operation data associated with an execution of at least one operation of the set of operations. The computer-implemented method further includes determining, by the computer, change data associated with the at least one operation of the set of operations based on the ontology data and the operation data. The computer-implemented method further includes identifying, by the computer, one or more subsets of the hierarchal structure based on the change data. The one or more subsets include a first subset associated with the at least one operation and at least one second subset associated with the first subset. The computer-implemented method further includes updating, by the computer, each subset of the one or more subsets of the hierarchal structure based on the change data and the ontology data. Further, the computer-implemented method includes outputting, by the computer, the updated one or more subsets of the hierarchal structure.

In various embodiments of the disclosure, the computer-implemented method further includes receiving, by the computer, application data associated with each application of a plurality of applications. The computer-implemented method further includes identifying, by the computer, at least one application of the plurality of applications associated with at least one subset of the one or more subsets based on the application data and the ontology data. The computer-implemented method further includes updating, by the computer, the application data associated with the at least one application of the plurality of applications based on the updated one or more subsets of the hierarchal structure. Further, the computer-implemented method includes outputting, by the computer, the updated application data associated with the at least one application. Further, the computer-implemented method includes controlling, by the computer, the execution of the at least one operation of the set of operations, wherein the execution is based on the updated application data.

In various embodiments of the disclosure, the change data is indicative of at least one of a merging of the one or more subsets, or a splitting of the one or more subsets. The computer-implemented method further includes generating, by the computer, integration data associated with the at least one application based on the updated one or more subsets of the hierarchal structure and the updated application data. The integration data indicates a positive integration of the at least one application or a negative integration of the at least one application. The computer-implemented method further includes outputting, by the computer, the integration data for an update of the at least one application.

In various embodiments of the disclosure, the computer-implemented method further includes receiving, by the computer, requirement data associated with the at least one application of the plurality of applications. The requirement data includes one or more updated characteristics associated with a functionality of the at least one application. The computer-implemented method further includes identifying, by the computer, the one or more subsets of the hierarchal structure based on the requirement data. The computer-implemented method further includes updating, by the computer, each subset of the identified one or more subsets of the hierarchal structure based on the one or more updated characteristics.

In various embodiments of the disclosure, the operation data includes visual data associated with the execution of the at least one operation within a virtual environment. The visual data includes augmented reality (AR) data, mixed reality (MR) data, or virtual reality (VR) data.

In various embodiments of the disclosure, the computer-implemented method further includes generating, by the computer, virtual data associated with the execution of the at least one operation within the virtual environment. The virtual data is generated based on the visual data associated with the virtual environment and the updated one or more subsets of the hierarchical structure. The computer-implemented method further includes rendering, by the computer, the virtual data on one or more user devices.

In various embodiments of the disclosure, the computer-implemented method further includes determining, by the computer, relationship data associated with the hierarchical structure based on the ontology data. The relationship data indicates a plurality of links, such that each link of the plurality of links defines a relationship between two entities of the plurality of entities. The computer-implemented method further includes determining, by the computer, a plurality of subsets associated with the hierarchical structure of the process ontology based on the relationship data. The plurality of subsets includes the one or more subsets. Each subset of the plurality of subsets includes at least one entity of the plurality of entities. The at least one entity of each subset of the plurality of subsets defines at least one of a specific domain or a specific function within the process ontology.

In various embodiments of the disclosure, the computer-implemented method further includes determining, by the computer, a subset of the relationship data associated with each subset of the one or more subsets based on the relationship data. The subset of the relationship data indicates an interdependency between the first subset and the at least one second subset. The computer-implemented method further includes updating, by the computer, the subset of the relationship data based on the change data. The computer-implemented method further includes updating, by the computer, each subset of the one or more subsets of the hierarchal structure based on the updated subset of the relationship data.

In various embodiments of the disclosure, the process ontology is a business ontology. Each subset of the one or more subsets is associated with a sub-ontology of the business ontology. Each sub-ontology is associated with a business application function.

In various embodiments of the disclosure, the operation data indicates an anomaly associated with the execution of the at least one operation. The computer-implemented method further includes generating, by the computer, notification data associated with the updated one or more subsets of the hierarchal structure. The computer-implemented method further includes transmitting, by the computer, the notification data to one or more user devices associated with the hierarchical structure of the updated one or more subsets.

In various embodiments of the disclosure, the computer-implemented method further includes receiving, by the computer, historical data associated with each historical hierarchical structure of a plurality of historical hierarchical structures. Each historical hierarchical structure of the plurality of historical hierarchical structures is associated with a historical process ontology. The computer-implemented method further includes training, by the computer, an artificial intelligence (AI) model based on the historical data. The AI model is trained to identify one or more change parameters associated with each historical hierarchical structure of the plurality of historical hierarchical structures. The computer-implemented method further includes applying, by the computer, the trained AI model to the hierarchical structure of the process ontology. The computer-implemented method further includes predicting, by the computer, modification data associated with the hierarchical structure over a time period based on the application of the trained AI model. The computer-implemented method further includes updating, by the computer, the hierarchal structure over the time period based on the modification data.

In various embodiments of the disclosure, a computer system for updating subsets of process ontology is described. The computer system includes a processor set, one or more computer-readable storage media, and program instructions stored on the one or more computer-readable storage media. The program instructions executable by the processor set to cause the processor set to receive ontology data associated with a business ontology. The business ontology includes a hierarchal structure of a plurality of domains. The ontology data indicates a set of operations associated with each domain of one or more domains of the plurality of domains. The program instructions further cause the processor set to receive update data associated with an execution of at least one operation of the set of operations. The program instructions further cause the processor set to generate operation data associated with the execution of at least one operation of the set of operations. The program instructions further cause the processor set to determine change data associated with the at least one operation of the set of operations based on the ontology data and the operation data. The program instructions further cause the processor set to identify one or more sub-ontologies of the business ontology within the hierarchical structure based on the change data. The one or more sub-ontologies include a first sub-ontology associated with the at least one operation and at least one second sub-ontology associated with the first sub-ontology. The program instructions further cause the processor set to update each sub-ontology of the one or more sub-ontologies within the hierarchal structure based on the change data and the ontology data. Further, the program instructions cause the processor set to output the updated one or more sub-ontologies within the hierarchal structure.

In various embodiments of the disclosure, the program instructions cause the processor set to receive application data associated with each application of a plurality of applications. The program instructions cause the processor set to identify at least one application of the plurality of applications associated with at least one sub-ontology of the one or more sub-ontologies based on the application data and the ontology data. The program instructions cause the processor set to update the application data associated with the at least one application of the plurality of applications based on the updated one or more sub-ontologies within the hierarchal structure. The program instructions cause the processor set to output the updated application data associated with the at least one application. The program instructions cause the processor set to control an execution of the at least one operation of the set of operations. The execution is based on the updated application data.

In various embodiments of the disclosure, the change data is indicative of at least one of a merge of the one or more sub-ontologies, or a split of the one or more sub-ontologies. The program instructions cause the processor set to generate integration data associated with the at least one application based on the updated one or more sub-ontologies and the updated application data. The integration data indicates at least one of a positive integration of the at least one application, or a negative integration of the at least one application. The program instructions cause the processor set to output the integration data to trigger the update of the at least one application.

In various embodiments of the disclosure, the program instructions cause the processor set to receive requirement data associated with the at least one application of the plurality of applications. The requirement data includes one or more updated characteristics associated with a functionality of the at least one application. The program instructions cause the processor set to identify the one or more sub-ontologies within the hierarchal structure based on the requirement data. The program instructions cause the processor set to update each sub-ontology of the identified one or more sub-ontologies within the hierarchal structure based on the one or more updated characteristics.

In various embodiments of the disclosure, the update data is received as part of at least one of user input data, visual data, or the application data associated with the at least one application.

In various embodiments of the disclosure, the program instructions cause the processor set to determine relationship data associated with the hierarchical structure based on the ontology data. The relationship data indicates a plurality of links. Each link of the plurality of links defines a relationship between two domains of the plurality of domains. The program instructions cause the processor set to determine a plurality of sub-ontologies associated with the hierarchical structure of the business ontology based on the relationship data. The plurality of sub-ontologies includes the one or more sub-ontologies. Each sub-ontology of the plurality of sub-ontologies includes at least one domain of the plurality of domains. The at least one domain of each sub-ontology of the plurality of sub-ontologies defines at least a specific function within the business ontology.

In various embodiments of the disclosure, the program instructions cause the processor set to determine sub-ontology relationship data associated with each sub-ontology of the one or more sub-ontologies based on the relationship data. The sub-ontology relationship data indicates an interdependency between the first sub-ontology and the at least one second sub-ontology. The program instructions cause the processor set to update the sub-ontology relationship data based on the change data. The program instructions cause the processor set to update each sub-ontology of the one or more sub-ontologies of the hierarchal structure based on the updated sub-ontology relationship data.

In various embodiments of the disclosure, the operation data indicates an anomaly associated with the execution of the at least one operation. The program instructions cause the processor set to generate notification data associated with the updated one or more sub-ontologies of the hierarchal structure. The program instructions cause the processor set to transmit the notification data to one or more user devices associated with the hierarchical structure of the updated one or more sub-ontologies.

In various embodiments of the disclosure, a computer-program product for updating subsets of process ontology is described. The computer-program product includes one or more computer-readable storage media and program instructions stored on the one or more computer-readable storage media to perform operations including receiving ontology data associated with the process ontology. The process ontology includes a hierarchal structure of a plurality of entities. The ontology data indicates a set of operations associated with each entity of one or more entities of the plurality of entities. The operations include receiving operation data associated with an execution of at least one operation of the set of operations. The operations include determining change data associated with the at least one operation of the set of operations based on the ontology data and the operation data. The operations include identifying the one or more subsets of the hierarchal structure based on the change data. The one or more subsets include a first subset associated with the at least one operation and at least one second subset associated with the first subset. The operations further include updating each subset of the one or more subsets of the hierarchal structure based on the change data and the ontology data. Further, the operations include outputting the updated one or more subsets of the hierarchal structure.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or collection, but this does not render the storage device as transitory because the data is not transitory while it is stored.

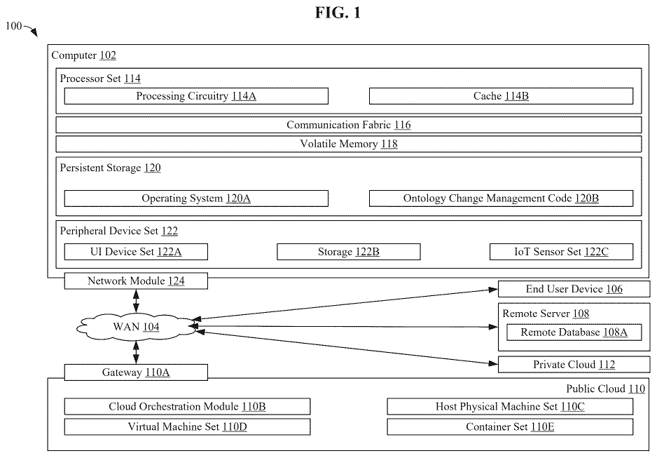

FIG. 1 is a diagram that illustrates a computing environment for updating subsets of process ontology, in accordance with an embodiment of the disclosure. With reference to FIG. 1, there is shown a computing environment 100 that contains an example of an environment for the execution of at least some of the computer code involved in performing the disclosed methods, such as an ontology change management code 120B. In addition to the ontology change management code 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the ontology change management code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch, a robot, or wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method is distributed among multiple computers and/or between multiple locations. On the other hand, in this presentation of the computing environment 100, detailed discussion is focused on a single computer, specifically the computer 102, to keep the presentation as simple as possible. The computer 102 is located in a cloud, even though it is not shown in a cloud in FIG. 1. On the other hand, computer 102 is not required to be in a cloud except to any extent as is affirmatively indicated.

The processor set 114 includes one, or more, computer processors of any type now known or to be developed in the future. The processing circuitry 114A is distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 is located “off-chip.” In some computing environments, the processor set 114 is designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in several types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods are stored in the dynamic modification of the ontology change management code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 is distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the ontology change management code 120B typically includes at least some of the computer code involved in performing the disclosed methods.

The peripheral device set 122 includes the set of peripheral devices of computer 102. Data communication connections between the peripheral devices and the other components of computer 102 are implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage is provided by peripheral storage devices designed for storing very large amounts of data, such as a storage area network (SAN) that is shared by multiple, geographically distributed computers. The IoT sensor set 122C is made up of sensors that may be used in Internet of Things applications. For example, one sensor is a thermometer, and another sensor is a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In some embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 is replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 may display, or otherwise present recommendations to an end user. In some embodiments of the disclosure, EUD 106 is a client device, such as a thin client, heavy client, mainframe computer, desktop computer, and so on.

The remote server 108 is any computer system that serves at least some data and/or functionality to the computer 102. The remote server 108 is controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data is provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs are stored as images and are transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in some embodiments of the disclosure, a private cloud is disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

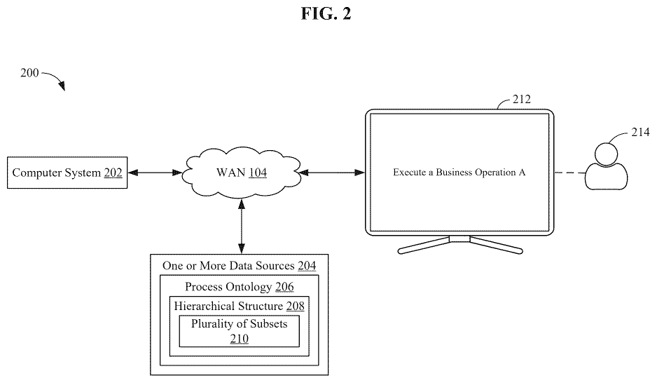

FIG. 2 is a diagram that illustrates a network environment for updating one or more subsets of a process ontology, in accordance with an embodiment of the disclosure. FIG. 2 is explained in conjunction with elements from FIG. 1. With reference to FIG. 2, there is shown a diagram of a network environment 200 for updating the one or more subsets of the process ontology. The network environment 200 includes a computer system 202 (referred to as system 202, hereinafter), and one or more data sources 204. The one or more data sources 204 may store a process ontology 206 that includes a hierarchal structure 208 of a plurality of entities. Further, the hierarchal structure 208 may include a plurality of subsets 210. Each subset of the plurality of subsets 210 may correspond to a particular domain or a business process. Further, each subset of the plurality of subsets 210 may represent knowledge and semantic data associated with the corresponding domain or business process. For example, each subset of the plurality of subsets 210 may correspond to a sub-ontology of the process ontology 206. The network environment 200 further includes the WAN 104 of FIG. 1. In an embodiment, the system 202 is an exemplary embodiment of the computer 102 in FIG. 1.

The system 202 may include suitable logic, circuitry, interfaces, and/or code that is configured for updating one or more subsets of the process ontology 206. The process ontology 206 is defined based on one or more domains or one or more processes of a business or an industry. The system 202 receives ontology data associated with the process ontology 206. The process ontology 206 includes the hierarchal structure 208 of a plurality of entities. Moreover, the ontology data indicates a set of operations associated with each entity of one or more entities of the plurality of entities. Further, the system 202 receives operation data associated with an execution of at least one operation of the set of operations. Further, the system 202 determines change data associated with the at least one operation of the set of operations based on the ontology data and the operation data. Further, the system 202 identifies one or more subsets of the hierarchal structure 208 based on the change data. The one or more subsets comprise a first subset associated with the at least one operation and at least one second subset associated with the first subset. Further, the system 202 updates each subset of the one or more subsets of the hierarchal structure 208 based on the change data and the ontology data. Further, the system 202 outputs the updated one or more subsets of the hierarchal structure 208.

Examples of the system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically by a computer system (such as the system 202). Each of the one or more data sources 204 may be designed to manage, store, retrieve, and update data efficiently. In an exemplary implementation, each data source of the one or more data sources 204 may correspond to a database. In such an implementation, a structure of the database corresponding to each data source of the one or more data sources 204 may involve tables, records, and fields that can be managed through various database management systems (DBMS).

In an embodiment of the disclosure, each data source of the one or more data sources 204 stores the process ontology 206 of the plurality of entities. Specifically, the one or more data sources 204 are connected with application programming interfaces (APIs) of a software application associated with a business. Examples of each data source of one or more data sources 204 may include but are not limited to, a relational database, a Non-Structured Query Language (SQL) database, a hierarchical database, a network database, a transactional database, a data warehouse, and a distributed database.

The network environment 200 further includes a user device 212 associated with a user 214. The user device 212 includes suitable logic, circuitry, and/or interfaces that are configured to execute one or more tasks within the network environment 200. The user device 212 performs the one or more tasks such as initiating an execution of a business process, processing data associated with the business process, and transmitting the data. In an embodiment of the disclosure, the system 202 receives operation data via the user device 212. The operation data indicates a change in the business process of the business. In an alternate embodiment of the disclosure, the system 202 renders updated subsets of the process ontology 206 on the user device 212. Examples of the user device 212 include, but are not limited to, a smartphone, a cellular phone, a mobile phone, a consumer electronic (CE) device, an Internet of Things (IoT) device, a computing device, a mainframe machine, a server, a computer workstation, or the like.

The plurality of entities may represent concepts or topics associated with a business or an industry to which the process ontology 206 relates. The process ontology 206 includes the hierarchical structure 208 of the plurality of entities. For example, at least some of the plurality of entities may form a sub-ontology or a subset of the hierarchical structure 208. Further, each of the plurality of subsets may indicate relationships between entities forming the corresponding subset. Moreover, each of the plurality of subsets may be connected directly or indirectly to a root entity of the hierarchical structure 208.

For example, the process ontology 206 is associated with a business. The process ontology 206 defines one or more business processes or one or more domains of the business. These one or more business processes or the one or more domains may indicate a functional model of the business, a way of operation of the business, various teams operating in the business, interactions between various functionalities and/or teams of the business, and so forth. The process ontology 206 may represent formalized rules and processes of the business. The process ontology 206 provides a way to establish, clarify, and retain key concepts or knowledge associated with the business.

In addition, semantic software programs may be utilized to incorporate rules and processes of the business, defined in the process ontology 206, into software applications and/or tools of the business. The semantic software programs may enable an integration of the software applications and/or tools with the process ontology 206, e.g., make the process ontology 206 machine-readable and machine-implementable. This may ensure that all systems, such as software tools and applications, predefined workflows, or other processes of the business are in agreement about knowledge and concepts of the business.

The process ontology 206 may define each of a plurality of business processes for one or more domains in a granular manner. Moreover, the process ontology 206 defines interrelations between the plurality of business processes. For example, a business process of the plurality of business processes may be common across multiple business processes. For example, there may be multiple software applications associated with the business. To this end, each of the multiple software applications may be in connection with each other based on a predefined workflow. For example, in a financial industry, a business process relating to “registering a new user” may be common or partly used across multiple other business processes. These other multiple business processes may include, for example, logging in by an existing user, password management for the user, one or more transaction-related rules applied to the user, and so forth.

The process ontology 206 maintains rules and processes of the business outside of a hard code of the software tools and applications executing the business process. Subsequently, the process ontology 206 allows users to change and/or update business rules and processes more quickly without programming and testing delays.

Over a period of time, one business process may be merged with another business process of the same or different business, new business process is added, an existing business process is updated, or an existing business process is removed, a corresponding process ontology, such as the process ontology 206 is changed. In such a case, the software application of the business associated with the business process being modified also needs to be adapted to align the software application with the change in the process ontology 206.

The system 202 of the present disclosure enables automated update of the process ontology 206 based on any change in a business process of the business. The system 202 may further utilize semantic software programs to initiate an update of one or more software applications associated with the business based on the change and the update in the process ontology 206. A manner in which the system 202 operates is described in detail in conjunction with FIG. 2 to FIG. 9.

The business corresponds to a structured organization or a structured entity that includes a plurality of employees working collaboratively to achieve specific objectives and goals. The business further includes or operates one or more software applications for carrying out one or more business processes of the business. Examples of the business include, but are not limited to, a health sector-based enterprise, a marketing sector-based enterprise, a finance sector-based enterprise, and the like.

In operation, the system 202 is configured to receive ontology data associated with the process ontology 206. The process ontology 206 comprises the hierarchal structure 208 of a plurality of entities. Moreover, the ontology data indicates a set of operations associated with each entity of one or more entities of the plurality of entities. For example, each entity of the plurality of entities indicates a concept or a domain associated with the business. Further, each of the one or more entities of the plurality of entities may be linked to a corresponding set of operations.

For example, the process ontology 206 may represent a business having a business process relating to warehouse management. In such a case, an entity ‘A’ may be associated with warehouse operations, an entity ‘B’ may be associated with customer service, an entity ‘C’ may be associated with stock, and an entity ‘D’ may be associated with accounts. To this end, each of the entities A, B, C, and D may be connected to a root entity. For example, the entities A, B, C, and D may form a first layer of the process ontology 206. In addition, one or more entities of the entities A, B, C, and D may be connected to other secondary entities of the plurality of entities. These secondary entities may form a second layer of the process ontology 206. Similarly, the secondary entities may be connected to tertiary entities forming a third layer. It may be noted that one or more entities of the same or different layers may be connected or correlated among themselves. For example, a secondary entity may be correlated to one or more entities of the entities A, B, C, and D, one or more secondary entities other than the secondary entity under consideration, and/or one or more tertiary entities. To this end, the process ontology 206 may include multiple subsets or sub-ontologies.

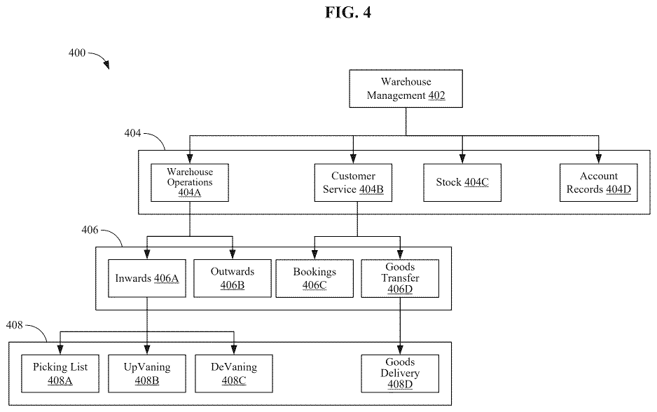

Further, each of one or more entities of the plurality of entities may be associated with the set of operations. For example, a set of operations associated with an entity, say the entity ‘A’, may define a business process or a business workflow. For example, the set of operations may be represented as a link between one or more datapoints that are pertinent to the entity ‘A’. For example, as the entity ‘A’ relates to the business process of warehouse operations, the set of operations pertinent to the entity ‘A’ may indicate one or more predefined workflows or one or more business processes for monitoring and/or executing different warehouse operations. It may be noted that entities present at the last layer of the process ontology 206 may not have further operations associated therewith. For example, this may occur as the entities present at the last layer of the process ontology 206 may correspond to the data layer of software applications. To this end, the ontology data includes the data (or metadata) associated with each entity of the plurality of entities and each operation of the set of operations for each of the one or more entities. Additional details of the process ontology 206 are provided in conjunction with FIG. 4.

The system 202 is further configured to receive operation data associated with an execution of at least one operation of the set of operations. The operation data may indicate a manner in which the at least one operation of the set of operations is executed. The operation data may include, but is not limited to, one or more operational parameters associated with the execution of the at least one operation. For example, the operation data may indicate information associated with the execution of the at least one operation associated with an entity of the process ontology 206.

For example, the at least one operation is associated with the set of operations associated with the entity A. Subsequently, the at least one operation may indicate a manner in which, for example, a user is executing a warehouse operation. For example, the at least one operation is associated with monitoring or execution of an inward warehouse operation, such as the devanning of a cargo. To this end, the system 202 is configured to receive operation data associated with the devanning of a cargo. For example, the operation data is provided by the user 214 via the user device 212, such as by providing certain inputs during or after the devanning process. Alternatively, the operation data is generated automatically based on monitoring, such as using a set of sensors, a camera, or a video live-stream of the devanning process. For example, the system 202 is configured to analyze a video or images associated with the devanning process to determine or generate the operation data.

The system 202 is configured to determine change data associated with the at least one operation of the set of operations based on the ontology data and the operation data. For example, the system 202 may retrieve a piece of the ontology data relating to the at least one operation. Further, the system 202 is configured to compare the piece of the ontology data with the operation data. Based on the comparison, the system 202 may identify whether the at least one operation has been executed in a predefined manner, such as described or defined in the process ontology 206, or if there is a deviation in the execution of the at least one operation.

For example, the at least one operation has a predefined flow of three steps indicated by: step 1: XYZ, step 2: PQR, and step 3: ABC. Such three predefined steps of executing the at least one operation may be defined in the process ontology 206. The system 202 may retrieve the piece of the ontology data indicating the details of the three predefined steps. Further, the operation data may indicate steps being performed during the execution of the at least one operation. For example, the operation data may indicate steps of the at least one operation as: step 1: XYZ and step 2: PQBC. To this end, the system 202 may compare the predefined flow of three steps indicated by the piece of the ontology data with the steps indicated by the operation data. Subsequently, the system 202 may identify a change. Moreover, change data associated with the change may indicate, for example, that the step 2 has been changed and the step 3 has been deleted. To this end, the change data indicates a modification in the execution of the at least one operation of the set of operations.

The system 202 is configured to identify one or more subsets of the hierarchal structure 208 based on the change data. The one or more subsets may include a first subset associated with the at least one operation and at least one second subset associated with the first subset. For example, when the change data indicates a change in the process ontology 206, the system 202 identifies a part of the process ontology 206 in which the change has occurred. In this regard, the system 202 identifies the one or more subsets of the hierarchal structure 208. For example, the hierarchical structure 208 may include a plurality of subsets, wherein each of the plurality of subsets corresponds to a sub-ontology of the process ontology 206. Subsequently, the system 202 identifies the one or more subsets or one or more sub-ontologies for which the change has occurred.

For example, the change data may indicate that the change has occurred in the entity ‘A’ associated with the at least one operation. Further, other entities and/or datapoints directly correlated with the entity ‘A’ may be identified. Such correlated entities and/or data points may indicate the first subset of the hierarchical structure 208. Once the first subset is identified, a link between the first subsets and/or other subsets of the hierarchical structure 208 is identified. For example, if a change occurs in an operation P of the entity A, and the entity A or a datapoint of the operation P is linked to the entity B or a datapoint of an operation associated with the entity B, then a change may also occur in the entity B. Subsequently, the system 202 identifies a second subset associated with the entity B or the datapoint of the operation associated with the entity B that needs to be updated in light of the change in the operation P of the entity A.

Thereafter, the system 202 is configured to update each subset of the one or more subsets of the hierarchal structure 208 based on the change data and the ontology data. In this regard, the system 202 may modify one or more datapoints associated with the at least one operation associated with an entity in which the change has occurred. Additionally, the system 202 is configured to modify other datapoint(s) and/or entities that are associated with the entity or the one or more datapoints associated with the at least one operation. In this manner, an effect of an update or modification in the first subset of the hierarchical structure 208 is also reflected in the at least one second subset of the hierarchical structure 208 when the at least one second subset is correlated or linked to the first subset.

Thereafter, the system 202 is configured to output the updated one or more subsets of the hierarchal structure 208. For example, the updated one or more subsets may be stored as part of the process ontology 206, such as by replacing the old one or more subsets. Moreover, the updated one or more subsets may be displayed, for example, on a display of the user device 212 for the validation thereof. For example, the outputted updated one or more subsets may be provided to the semantic software program for the update of a software application or a part thereof associated with the business.

It may be noted that before the update of each subset of the one or more subsets of the hierarchal structure 208, a validation process may be performed to validate the change data. Based on the validation, the change indicated by the change data may be identified as a valid change that has to be implemented or reflected in the process ontology 206. For example, a user, such as the user 214 associated with the business may validate the change data.

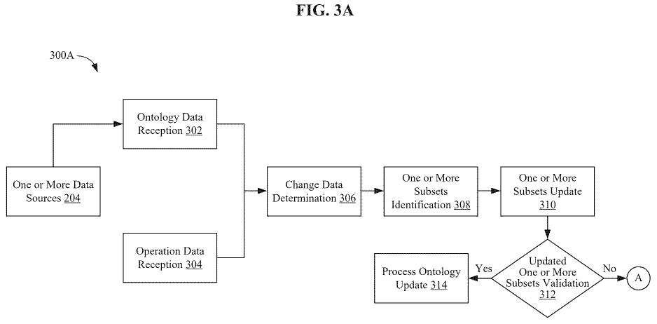

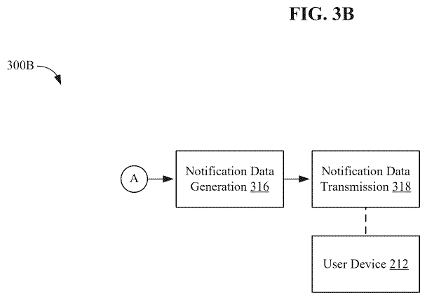

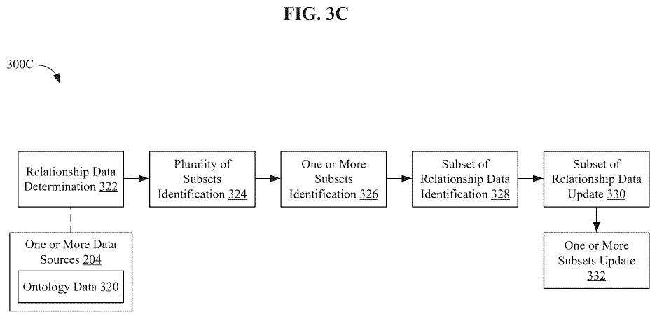

FIG. 3A is a diagram that illustrates exemplary operations for updating the process ontology 206, in accordance with an embodiment of the disclosure. FIG. 3A is explained in conjunction with elements from FIG. 1 and FIG. 2. With reference to FIG. 3A, there is shown a block diagram 300A that illustrates exemplary operations from 302 to 314, as described herein. The exemplary operations illustrated in the block diagram 300A start at 302 and are performed by any computing system, apparatus, or device, such as by the computer 102 of FIG. 1 or by the system 202 of FIG. 2. Although illustrated with discrete blocks, the exemplary operations associated with one or more blocks of the block diagram 300A can be divided into additional blocks, combined into fewer blocks, or eliminated, depending on the implementation.

At 302, an ontology data reception operation is performed. In the ontology data reception operation, the system 202 is configured to receive ontology data associated with the process ontology 206. In an example, the ontology data is received from the one or more data sources 204. The ontology data may define information associated with a shared conceptualization of a plurality of entities that are assumed to exist in one or more domains of a business or an enterprise. Each of the plurality of entities may correspond to an object, a concept, or any other entity within a domain of the business.

The process ontology 206 may be associated with a business. Further, the business may operate within one or more domains. For example, each domain may include multiple concepts, e.g., multiple entities from the plurality of entities. Further, multiple entities of a domain may indicate knowledge associated with concepts of the domain. Further, at least one entity of the multiple entities of the domain may indicate a set of operations for carrying out the concept. For example, in a healthcare-based business, a first domain may correspond to ‘diseases’, while a second domain may correspond to ‘patients’. Further, in the disease's domain, each entity, e.g., the concept, of multiple entities may relate to each of various diseases, such as heart disease, lung disease, cancer, kidney disease, and so forth. Additionally, for a concept, such as for the entity relating to heart disease, there may exist additional entities (referred to as sub-entities) or sub-concepts. Examples of the sub-entities may include, but are not limited to, tetralogy of Fallot, transposition of the great arteries (TGA), total anomalous pulmonary venous connection (TAPVC), truncus, and tricuspid valve abnormalities. Each of the sub-entities may be associated with a set of operations. For example, a set of operations associated with a sub-entity, say the sub-entity relating to truncus may define one or more steps for the diagnosis of an anomaly relating to truncus in the heart of a patient. The set of operations relating to the truncus may also define steps or processes for care, maintenance, etc. for the patient having the anomaly.

It may be noted that such an example of the process ontology 206 is only exemplary and should not be construed as a limitation. As may be noted, the process ontology 206 may relate to any type of business defining concepts of one or more domains of the business.

At 304, an operation data reception operation is performed. In the operation data reception operation, the system 202 is configured to receive operation data associated with an execution of at least one operation of the set of operations. For example, the set of operations may be associated with a specific entity of the plurality of entities. Further, the operation data may indicate a manner in which the at least one operation is being performed or has been performed. For example, the at least one operation may be performed by a user or within a software application associated with the business.

At 306, a change data determination operation is performed. In the change data determination operation, the system 202 is configured to determine change data associated with the execution of the at least one operation. In this regard, the system 202 may be configured to retrieve a piece of the ontology data associated with the specific entity, the at least one operation, or the set of operations associated with the specific entity. Further, the system 202 is configured to compare the piece of the ontology data with the operation data to determine the change data. The change data may indicate an occurrence of a change in the at least one operation, the nature of the change (such as insertion, deletion, or update), a timestamp associated with the change, a user or a programming process associated with the change, and so forth.

At 308, a one or more subsets identification operation is performed. In the one or more subsets identification operation, the system 202 is configured to identify the one or more subsets of the hierarchical structure 208 of the process ontology 206. For example, the one or more subsets of the hierarchical structure 208 are identified based on the change data and the ontology data. The system 202 is configured to identify a first subset in which the change has occurred, or at least one second subset that will get affected due to the change in the first subset.

For example, the system 202 is configured to identify the plurality of subsets 210 of the hierarchical structure 208. Further, based on the set of operations associated with the at least one operation, the system 202 is configured to identify one or more entities of the plurality of entities. The one or more entities are associated with the change in the at least one operation. Further, based on the one or more entities, the system 202 is configured to identify the first subset associated with the at least one operation. The first subset may correspond to a subset in which the change is made. Further, based on the first subset, the system 202 is configured to identify the at least one second subset which is associated with the first subset and may also need modification owing to the change in the first subset.

At 310, a one or more subset update operation is performed. In the one or more subset update operation, the system 202 is configured to update the one or more subsets based on the change data. As the change data indicates a change in the at least one operation associated with the first subset, the first subset is updated to represent a current execution of the at least one operation. Further, based on analyzing the ontology data and determining a correlation between the first subset and the at least one second subset, the at least one second subset is updated. For example, the updated one or more subsets may be outputted.

At 312, an updated one or more subsets validation operation is performed. In the updated one or more subsets validation operation, the system 202 is configured to determine whether the updated one or more subsets are validated or not. For example, the updated one or more subsets may be validated by a user of the business, such as the user 214. In an alternate embodiment, the updated one or more subsets may be validated by a validation software. For example, the validation software may assess the updated one or more subsets to check whether the updated one or more subsets conform to ontology modeling best practices. In other words, the validation software may check whether the updated one or more subsets contain any anomalies or pitfalls. In certain cases, the validation software may support different approaches to validate the updated one or more subsets. These different approaches for validation may include, but are not limited to, checking for consistency of the process ontology 206 in light of the updated one or more subsets, checking for compliance of the updated one or more subsets with a process ontology language used to build the process ontology 206, and checking for modeling mistakes in the updated one or more subsets.

In an example, the validation software may assess the updated one or more subsets to check a compliance of the updated one or more subsets with the process ontology language used to build the process ontology 206. For example, if a language of the updated one or more subsets is found to be compliant with the process ontology language, then the updated one or more subsets are validated. Alternatively, if the language of the updated one or more subsets is found to be not compliant with the process ontology language, then the updated one or more subsets are not validated and subsequently discarded, for example, not used further for updating the hierarchical structure 208 of the process ontology 206. In an alternate example, the validation software may assess the updated one or more subsets to check whether addition of the updated one or more subsets may lead to an anomaly in the existing hierarchical structure 208 of the process ontology 206. If the validation software identifies that an anomaly may occur due to the addition of the updated one or more subsets, then the updated one or more subsets are not validated.

When the updated one or more subsets are validated, at 314, a process ontology update operation is performed. In the process ontology update operation, the system 202 is configured to update the hierarchical structure 208 of the process ontology 206 based on the updated one or more subsets. After the validation, the updated one or more subsets may be stored as part of the hierarchical structure 208 of the process ontology 206. For example, the updated one or more subsets may replace existing one or more subsets in the hierarchical structure 208, thereby updating the process ontology 206 based on the change data.

Further, when the updated one or more subsets are not validated at 312, the operation moves to A. The operation of A has been described in detail in conjunction with, for example, FIG. 3B.

FIG. 3B is a diagram that illustrates exemplary operations for transmission of notification data, in accordance with an embodiment of the disclosure. FIG. 3B is explained in conjunction with elements from FIG. 1, FIG. 2, and FIG. 3A. With reference to FIG. 3B, there is shown a block diagram 300B that illustrates exemplary operations from 316 to 318, as described herein. The exemplary operations illustrated in the block diagram 300B start at 316 and are performed by any computing system, apparatus, or device, such as by the computer 102 of FIG. 1 or by the system 202 of FIG. 2. Although illustrated with discrete blocks, the exemplary operations associated with one or more blocks of the block diagram 300B can be divided into additional blocks, combined into fewer blocks, or eliminated, depending on the implementation.

At 316, a notification data generation operation is performed. In the notification data generation operation, the system 202 is configured to generate a notification based on the updated one or more subsets. For example, if the updated one or more subsets may not get validated, such as by the user 214 or the validation software. In such a case, the system 202 may recognize the presence or occurrence of an anomaly in the current execution of the at least one operation. Based on the identified anomaly, the system 202 is configured to generate the notification data. For example, the notification data may indicate, but is not limited to, the one or more subsets in which the change (an anomaly in the present case) has occurred, a timestamp of the execution of the at least one operation, an executor (such as a person or a software element) associated with the execution of the at least one operation having the anomaly, type of the anomaly, a severity of the anomaly, and a resolution process for the anomaly.

At 318, a notification data transmission operation is performed. In the notification data transmission operation, the system 202 is configured to transmit the notification data to a user associated with the business. For example, the user 214 may access or view the notification data via the user device 212. Subsequently, the user may carry out or execute the resolution process for resolving the anomaly. In an alternate example, the notification data may be transmitted to a resolution software tool. Further, the resolution software tool may execute the resolution process to resolve the anomaly.

It may be noted that in case where the change data is identified as an anomaly, no change or update may be made to the hierarchical structure 208 of the process ontology 206.

FIG. 3C is a diagram that illustrates exemplary operations for updating one or more subsets of the process ontology 206, in accordance with an embodiment of the disclosure. FIG. 3C is explained in conjunction with elements from FIG. 1, FIG. 2, FIG. 3A, and FIG. 3B. With reference to FIG. 3C, there is shown a block diagram 300C that illustrates exemplary operations from 322 to 332, as described herein. The exemplary operations illustrated in the block diagram 300C start at 322 and are performed by any computing system, apparatus, or device, such as by the computer 102 of FIG. 1 or by the system 202 of FIG. 2. Although illustrated with discrete blocks, the exemplary operations associated with one or more blocks of the block diagram 300C can be divided into additional blocks, combined into fewer blocks, or eliminated, depending on the implementation.

At 322, a relationship data determination operation is performed. In the relationship data determination operation, the system 202 is configured to determine the relationship data associated with the hierarchical structure 208 of the process ontology 206 based on ontology data 320. For example, the ontology data 320 may be stored within the one or more data sources 204. The ontology data 320 is associated with the process ontology 206. The ontology data 320 refers to a structured framework that defines relationships, concepts, and categories within one or more domains of knowledge of a business or an industry. The ontology data 320 provides a formal representation, in the form of the hierarchical structure 208, of the knowledge of the one or more domains, describing the concepts as entities, along with their attributes and interconnections between them.

Based on the ontology data 320, the system 202 is configured to determine the relationship data. The relationship data indicates a plurality of links or interconnections. Moreover, each link of the plurality of links defines a relationship between two entities of the plurality of entities. For example, a link may indicate a relationship or an interconnection between two entities of the process ontology 206. The link may define how the two entities or concepts are associated. These plurality of links may indicate a structure of how various entities in the one or domains are interrelated. For example, the link of the plurality of links between two entities, say entity ‘A’ and entity ‘B’, may correspond to one of a plurality of relationship types. These plurality of relationships types may include, but are not limited to, hierarchical relationship (such as, the entity ‘A’ is a subclass of the entity ‘B’, or the entity ‘B’ is a superclass of the entity ‘A’), a part-whole relationship (such as, the entity ‘A’ is a part of the entity ‘B’, or the entity ‘B’ has a part of the entity ‘A’), associative relationship (such as, the entity ‘A’ is related to the entity ‘B’, or the entity ‘A’ is connected to the entity ‘B’), functional relationship (such as, the entity ‘A’ has entity ‘B’, or the entity ‘A’ requires entity ‘B’), temporal relationship (such as, the entity ‘A’ occurs before or after the entity ‘B’, or the entity ‘A’ occurs during the entity ‘B’), causal relationship (such as, the entity ‘A’ causes the entity ‘B’, or the entity ‘A’ results in the entity ‘B’), equivalence relationship (such as, the entity ‘A’ is equivalent to entity ‘B’), role-based relationship (such as, the entity ‘A’ performs entity ‘B’, or the entity ‘A’ is an entity ‘B’), logical relationship (such as, if entity ‘A’ occurs then perform entity ‘B’), and ownership and control relationship (such as, entity ‘A’ owns or manages entity ‘B’).

At 324, a plurality of subsets identification operation is performed. In the plurality of subsets identification operation, the system 202 is configured to identify the plurality of subsets 210 of the hierarchical structure 208 of the process ontology 206 based on the relationship data. In this regard, each subset of the plurality of subsets 210 includes at least one entity of the plurality of entities forming the process ontology 206. Moreover, the at least one entity of each subset of the plurality of subsets 210 defines at least one of a specific domain or a specific function within the process ontology 206.

For example, the plurality of subsets 210 may indicate specific portions or divisions of the hierarchical structure 208 of the process ontology 206. Each subset of the plurality of subsets 210 may focus on a particular area or application, a particular sub-domain, or a set of concepts. The plurality of subsets 210 may help to organize the process ontology 206 into smaller and manageable parts, which may be useful; for specific applications, easier maintenance, and a better understanding of the process ontology 206. The plurality of subsets 210 allows scalability of the process ontology 206, such that new subsets may be added without affecting the entire process ontology 206. For example, a set of concepts of a subset of the hierarchical structure 208 may be represented as the at least one entity within the subset. Further, the at least one entity within the subset defines a specific domain or a specific function within the process ontology 206. For example, the at least one entity of the subset may represent the subset as a domain subset, a task-specific subset, an application-specific subset, a granularity subset, a role-based subset, a conceptual subset, and so forth.

At 326, a one or more subsets identification operation is performed. In the one or more subsets identification operation, the system 202 is configured to identify the one or more subsets from the plurality of subsets 210 associated with the change data. The plurality of subsets 210 may include the one or more subsets. Further, based on the change data indicating a change associated with the execution of the at least one operation, the one or more subsets are identified. The one or more subsets may be indicative of subsets in which a change has occurred, thereby requiring a need for update. Details of the identification of the one or more subsets are described in conjunction with, for example, FIG. 3A.

At 328, a subset of relationship data identification operation is performed. In the subset of relationship data identification operation, the system 202 is configured to identify the subset or a piece of the relationship data associated with each of the one or more subsets based on the relationship data. The subset of the relationship data indicates an interdependency between the first subset and the at least one second subset. For example, a subset of the relationship data may correspond to a piece of the ontology data 320 that relates to a subset of the hierarchical structure 208 to be updated. The subset of the relationship data may indicate interdependencies within entities or datapoints of the subset of the hierarchical structure 208 which has to be updated.

Based on the subset of the relationship data, various interdependencies, correlations, or links between the entities of the one or more subsets are identified. This enables an understanding of how the change in the at least one operation may affect operations or functionalities of entities of the same subset or other subsets from the one or more subsets.

At 330, a subset of relationship data update operation is performed. In the subset of relationship data update operation. The system 202 is configured to update the subset of relationship data associated with each of the one or more subsets of the hierarchical structure 208 based on the change data and the relationship data. The one or more subsets may include the first subset associated with the at least one operation in which the change has occurred, and at least one second subset associated with or correlated to the first subset. For example, the subset of relationship data associated with the first subset may be updated to indicate the current execution of the at least one operation. Moreover, the subset of relationship data associated with the at least one second subset may be updated to indicate an updated relation or an updated manner of execution of operations of the at least one second subset.

At 332, a one or more subsets update operation is performed. In the one or more subsets update operation, the system 202 is configured to update each subset of the one or more subsets of the hierarchal structure 208 based on the updated subset of the relationship data. For example, the updated subset of the relationship data indicates the change in the at least one operation of a set of operations associated with an entity of the first subset, as well as any change arising due to interdependency between the first subset and the at least one second subset. Subsequently, the update of the one or more subsets may indicate the change in the hierarchical structure 208 of the process ontology 206 based on the change data. Details of the update of the one or more subsets are described in conjunction with, for example, FIG. 3A.

FIG. 4 is a diagram that illustrates an exemplary process ontology, in accordance with an embodiment of the disclosure. FIG. 4 is explained in conjunction with elements of FIG. 1, FIG. 2, FIG. 3A, FIG. 3B, and FIG. 3C. With reference to FIG. 4, there is shown a diagram 400 of the process ontology 206. The diagram 400 of the process ontology 206 is associated with a business or an enterprise relating to warehouse management.

The process ontology 206 comprises the hierarchical structure 208. According to the present example, the hierarchical structure 208 is represented as a tree structure. The hierarchical structure 208 of the process ontology 206 may organize a plurality of entities of the process ontology 206 into levels. The plurality of entities may include a first entity 402, a plurality of second entities 404 (depicted as an entity 404A, an entity 404B, an entity 404C, and an entity 404D, and collectively referred to as second entities 404). The plurality of entities may further include a plurality of third entities 406 (depicted as an entity 406A, an entity 406B, an entity 406C, and an entity 406D, and collectively referred to as third entities 406), and a plurality of fourth entities 408 (depicted as an entity 408A, an entity 408B, an entity 408C, and an entity 408D, and collectively referred to as fourth entities 408).

The hierarchical structure 208 may represent the plurality of entities of the process ontology 206 in one or more layers or levels. Each of the plurality of entities in each of the one or more layers may define a concept associated with the business, e.g., warehouse management. Further, high-level entities, such as the second entities 404 may be more fundamental than low-level entities, such as the fourth entities 408. In other words, the high-level entities, such as the second entities 404 may exist without low-level entities, while the low-level entities, such as the fourth entities 408 cannot exist without the high-level entities.

The process ontology 206 provides a shared understanding of common domains and contributes to resolving interoperability issues among various domains and functions of the business as well as various aspects of software applications across different domains or functionality of the business.

For example, a hierarchy of the hierarchical structure 208 of the process ontology 206 may be defined by users associated with the warehouse management business. In an alternate example, the hierarchy of the hierarchical structure 208 may be defined by analyzing various documents, contents, requirements, etc. associated with the business. For example, at first, a scope of the process ontology 206 is determined. Determining the scope may include identifying an industry of the business or one or more domains pertinent to the business. For example, an ontology for a healthcare industry-related business may have different domains, concepts, relationships, and properties than an ontology for a finance industry-related business. Once the scope is defined, information associated with each of the one or more domains is gathered by analyzing information from various documents, contents, requirements, and other resources associated with the business. This information may be gathered from a variety of sources including, but not limited to, industry standards and regulations, published articles and research papers, interviews with subject matter experts, business process documents and workflows, user stories associated with users of the business or users pertinent to the one or more domains of the business, and use cases associated with the one or more domains of the business.

Further, the information associated with each of the one or more domains is analyzed to identify the key concepts and relationships in each of the one or more domains of the business. Subsequently, a preliminary hierarchical structure for the process ontology 206 is developed. For example, the preliminary hierarchical structure may be designed and/or updated by users associated with the business who have a deep understanding of the at least one of the one or more domains and can identify concepts and relationships to be included in the process ontology 206.

Pursuant to the present example, the hierarchical structure 208 is organized into a tree-like structure, with one or more high-level entities, such as the second entities 404 at the top of the hierarchical structure 208 or the tree. Moreover, specific entities associated with specific concepts may be branching out from the one or more high-level entities. For example, a healthcare business-related ontology may have an entity associated with the concept of ‘patient’ and an entity associated with the concept of ‘medical condition’ as high-level entities. Further, specific entities relating to concepts of ‘heart disease’ and ‘cancer’ may be branching out from the entity relating to the ‘medical condition’.

Once the preliminary hierarchical structure for the process ontology 206 is developed based on an analysis of the one or more domains, the preliminary hierarchical structure may serve as the foundation for the development of the process ontology 206 to reach the hierarchical structure 208.

For example, each of the plurality of entities or concepts of the process ontology 206 is identified uniquely and defines or represents metadata associated therewith. For example, the metadata for an entity may indicate a business functionality or a set of operations. For example, each of the identified concepts may be used to build the process ontology 206, such that the concepts are defined as entities in the hierarchical structure 208 of the process ontology 206. Each of the plurality of entities may be defined in a way that is unambiguous and can be easily understood by both humans and machines. In other words, each of the plurality of entities may have a unique identifier and associated metadata, which may define or represent information including, but not limited to, a name, a definition, one or more synonyms, one or more attributes, one or more relationships, one or more examples or use cases, and a set of operations or functionality. A name of an entity may be a descriptive label or a term that identifies a corresponding concept, a definition of the entity may indicate a clear and concise explanation of what the concept represents and how it relates to other concepts in the hierarchical structure 208, one or more synonyms may indicate alternative labels or terms that may be used to refer to the concept, and one or more attributes may indicate additional properties or characteristics that describe the concept. For example, the one or more attributes of the entity may indicate a data type associated with the entity, range or units of measure associated with the entity, and so forth. Further, the one or more relationships may indicate one or more linkages, such as semantic linkages in which the concept is related to other concepts in the process ontology 206, such as in a parent-child relationship, a part-whole relationship, or an association relationship. The one or more examples or use cases may indicate concrete instances or scenarios that illustrate the concept and its usage in real-world contexts. Further, the set of operations may indicate a functionality, or processes associated with carrying out tasks pertinent to the entity.

For example, a structure, consistency, and maintenance of the process ontology 206 is defined based on the metadata associated with each entity of the plurality of entities. The metadata may also support automated reasoning and inference from the process ontology 206, which can help to identify errors, anomalies, or inconsistencies in the process ontology 206 and enable intelligent decision-making based on data represented by the process ontology 206. It may be noted that the process ontology 206 may also be referred to as a business ontology.

Pursuant to the present example, the process ontology 206 is associated with warehouse management. In such a case, the first entity 402 may correspond to a root node of the hierarchical structure 208. The first entity 402 indicates a concept or a domain associated with warehouse management. Warehouse management encompasses the concepts and processes involved in running day-to-day operations of a warehouse. The warehouse management includes receiving and organizing warehouse space, scheduling labor, managing inventory, and fulfilling orders. Moreover, for effective warehouse management, each of these processes may be optimized, such as to reduce costs, wastage, and so forth, and integrated with each other to ensure that all aspects of a warehouse operation work together to increase productivity and keep costs low.

Further, the first entity 402 branches out into the second entities 404. The second entities 404 may indicate or represent a high-level or fundamental process for warehouse management. For example, the entity 404A is associated with a concept of warehouse operations, the entity 404B is associated with a concept of customer service, the entity 404C is associated with a concept of stock, and entity 404D is associated with a concept of account records. The warehouse operations concept may define a process of receiving goods or products, storing the goods or products, and shipping the goods or products. Subsequently, the entity 404A branches out to entities 406A and 406B of the third entities 406. The entity 406A represents a concept of inward bound or flow of goods or products, e.g., receiving of the goods or products. Further, the entity 406B represents a concept of outward bound or flow of goods or products, e.g., shipping of the goods or products. Further, the entity 406A relating to the concept of inward bound of the goods or products branches out to entities 408A, 408B, and 408C of the fourth entities 408. The entity 408A represents or defines a concept of a picking list. The picking list may correspond to an all-inclusive document sent to warehouse managers for order fulfillment. The picking list may include multiple items from which desired items may be selected. This may ensure that the right products or goods are selected, expedite the picking process, and reduce fulfillment time. To this end, the concept of the picking list may be associated with a process of item selection. Further, the entity 408B represents or defines a concept of upvaning. The concept of upvaning may be associated with a process of loading goods or cargo into a shipping container or a transportation vehicle for transport. The upvaning is associated with the items selected by the warehouse manager for delivery to the warehouse. The upvaning concept may also include arranging and securing the items within the container or vehicle to optimize space utilization, ensure stability, and protect the goods during transportation. Further, the entity 408C represents or defines a concept of devaning. The concept of the devaning may be associated with a process of unloading goods or cargo from a shipping container or a transportation vehicle for storage within the warehouse. The devaning is associated with the unloading of the items selected by the warehouse manager for delivery to the warehouse. The devaning concept may also include inspection and/or unpacking of the unloaded goods or cargo.

Further, the entity 404B is associated with the concept of customer service. The concept of the customer service may include communicating with customers, handling orders, resolving issues, and ensuring customer satisfaction. Subsequently, the entity 404B branches out to entities 406C and 406D of the third entities 406. The entity 406C represents a concept of bookings of goods or products, e.g., receiving orders for goods or products stored in the warehouse. Further, the entity 406D represents a concept of goods transfer, e.g., ensuring that the right goods or products are shipped to the customers in the right conditions. Further, the entity 406D relating to the concept of goods transfer branches out to entity 408D. The entity 408D represents a concept of goods delivery. The goods delivery concept may include an assessment of goods or products delivered to a customer based on one or more parameters, such as the condition of goods or products delivered, time frame of delivery, delivery of the right goods or products based on booking, and so forth.

Further, the entity 404C is associated with the concept of stock. The concept of stock may include a way of organizing stock flows in the warehouse. The concept of stock may be concerned with having an adequate level of stock in the warehouse to competently meet customer demand at a low cost for the company. For example, the concept of stock may branch out to entities associated with a concept of, but not limited to, product catalog, stock keeping unit, pallet, size of a stock of a product or a good, weight of a stock of a product or a good, and storage temperature for a stock of a product or a good.

Further, the entity 404D is associated with the concept of account records. The concept of the account records may include information or knowledge associated with money that the business owes to its suppliers or creditors for goods and services received on credit. The account records may include information or knowledge associated with money that the business is owed from its customers as well as other payables, such as salaries, maintenance, etc. associated with the warehouse. For example, the concept of account records may branch out to entities associated with a concept of, but not limited to, received consignment delivery invoices, invoice generation, invoice verification, record maintenance, payment schedule, credit assessments, payment tracking, overdue payment processes, and other expense trackers.

It may be noted that such an example of the warehouse management-related process ontology is only exemplary and should not be construed as a limitation. In certain cases, the warehouse management-related process ontology may include additional or fewer components depending on the size, products, etc. of the business. Moreover, the process ontology 206 may be associated with any industry, such as, but not limited to, the financial industry, healthcare industry, software as a service (SaaS) industry, construction industry, manufacturing industry, and so forth.

Moreover, the representation of the hierarchical structure 208 of the process ontology as a tree is also exemplary. In an alternate example, the hierarchical structure 208 may be implemented using a directed acyclic graph (DAG).

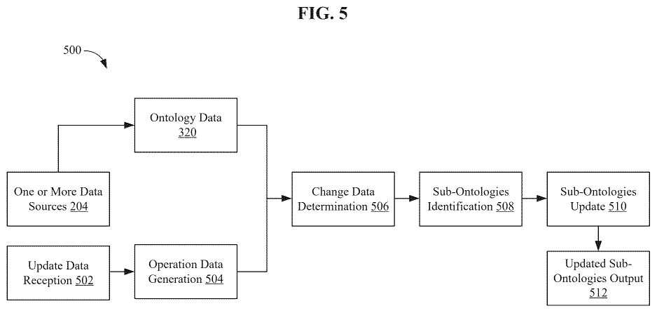

FIG. 5 is a diagram that illustrates exemplary operations for updating sub-ontologies of the process ontology 206, in accordance with an embodiment of the disclosure. FIG. 5 is explained in conjunction with elements from FIG. 1, FIG. 2, FIG. 3A, FIG. 3B, FIG. 3C and FIG. 4. With reference to FIG. 5, there is shown a block diagram 500 that illustrates exemplary operations from 502 to 512, as described herein. The exemplary operations illustrated in the block diagram 500 start at 502 and are performed by any computing system, apparatus, or device, such as by the computer 102 of FIG. 1 or by the system 202 of FIG. 2. Although illustrated with discrete blocks, the exemplary operations associated with one or more blocks of the block diagram 500 can be divided into additional blocks, combined into fewer blocks, or eliminated, depending on the implementation.

At 502, an update data reception operation is performed. In the update data reception operation, the system 202 is configured to receive update data associated with an execution of the at least one operation of the set of operations. The update data may indicate a modification associated with the execution of the at least one operation. For example, the update data may be received as a user input from a user, such as the user 214 associated with the business. In an alternate example, the update data may be generated automatically, such as by a software tool or an artificial intelligence (AI) tool operating within a business environment. For example, the update data may be generated based on a change in standardized rules and regulations for carrying out certain operations, change in compliance, identification of an industry-wide norm for improving certain operations, and so forth.

At 504, an operation data generation operation is performed. In the operation data generation operation, the system 202 is configured to generate operation data associated with the execution of the at least one operation of the set of operations based on the update data. For example, the operation data may indicate a manner in which the at least one operation is to be executed in light of the modification specified in the update data.

In addition, the ontology data 320 associated with the process ontology 206 is received. In an example, the system 202 is configured to receive ontology data 320 from the one or more data sources 204. Details associated with the operation of receiving the ontology data are described in conjunction with, for example, FIG. 3A.

Further, based on the plurality of subsets 210 of the hierarchical structure 208 of the process ontology 206, the system 202 is configured to identify an entity and/or a set of operations to which the modification in the update data relates. Thereafter, the system 202 is configured to update the at least one operation of the set of operations relating to the entity based on the modification in the update data. To this end, the updated at least one operation may correspond to the operation data associated with the execution of the at least one operation in an updated manner.

Returning to the example of the process ontology 206 being associated with warehouse management, the update data may be associated with an integration of an automation process, for example, an automated process for classification and sorting of goods or products. In such a case, the update data received from a user may indicate tools, criteria, and processes for automated classification and sorting of goods or products. Based on the update data and the ontology data, the system 202 is configured to identify which subset(s) of the plurality of subsets 210 is associated with the at least one operation to be modified. For example, the system 202 may identify the entity 404C relating to the concept of stock to be associated with the update data of the automation process, e.g., the automation process may have to be integrated with the concept of stock. Subsequently, the operation data may be generated by integrating the automation process with current concepts or processes under the concept of ‘stocks’. For example, the integration of the automation process for the classification and sorting of goods or products leads to the creation of an additional concept within the stock concept which relates to controlling a robotic process for performing the automation process for the classification and sorting of goods or products. Moreover, the integration of the automation process with the entity 404C may also lead to the deletion or modification of current practices, such as manual processes of classification and sorting of the products or goods. To this end, the operation data may indicate a modified manner of execution of the existing at least one operation as well as the addition of operation(s) under the existing entity 404C. It may be noted that such an example of the generation of the operation data is only exemplary and should not be construed as a limitation.

At 506, a change data determination operation is performed. In the change data determination operation, the system 202 is configured to identify a change or modification in the execution of the at least one operation. Details of the change data determination operation are described in conjunction with, for example, FIG. 3A.

At 508, a sub-ontologies identification operation is performed. In the sub-ontologies identification operation, the system 202 is configured to identify one or more sub-ontologies of the process ontology 206 in which the modification or update is to be made. The one or more sub-ontologies may be directly or indirectly associated with the at least one operation to be updated. It may be noted that one or more sub-ontologies may correspond to the one or more subsets of the hierarchical structure 208. Details of the identification of the one or more subsets or the one or more sub-ontologies are described in conjunction with, for example, FIG. 3A.

For example, the process ontology 206 is a business ontology. Moreover, each of the plurality of subsets 210 is associated with a sub-ontology of the business ontology. Similarly, each subset of the one or more subsets is associated with a sub-ontology of the process ontology 206. It may be noted that each sub-ontology associated with each of the plurality of subsets 210 may correspond to a subset of the process ontology 206 which is an independently valid ontology. For example, each of the sub-ontology for each of the plurality of subsets 210 is associated with a business application function. The business application function may correspond to a sub-domain or a concept in a field or domain of business associated with the process ontology 206.

At 510, a sub-ontologies update operation is performed. In the sub-ontologies update operation, the system 202 is configured to update the one or more sub-ontologies of the process ontology 206. The one or more sub-ontologies may be associated with the at least one operation of the change data. Further, the update of the one or more subsets may correspond to the update of the one or more sub-ontologies. Details of the one or more subsets or the one or more sub-ontologies are described in conjunction with, for example, FIG. 3A.

At 512, an updated sub-ontologies output operation is performed. In the updated sub-ontologies output operation, the system 202 is configured to output the updated one or more sub-ontologies of the process ontology 206. For example, the updated one or more sub-ontologies may be rendered on a display. In an alternate example, the updated one or more sub-ontologies may be output to a downstream process, such as for validation. For example, the updated one or more sub-ontologies may be output independently or as a part of the process ontology 206.

Although the present example describes updating one or more subsets or one or more sub-ontologies of the process ontology 206, the present disclosure may not be so limiting. In addition to updating the process ontology, the system 202 is also configured to update software application(s) associated with the business based on the change data.

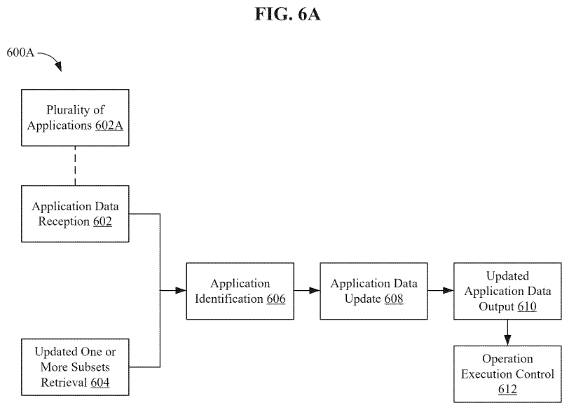

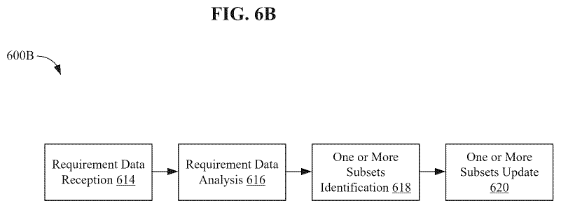

The system 202 enables the decomposition of the process ontology 206 into sub-ontologies or the plurality of subsets 210. Moreover, the system 202 is configured to provide two-way synchronization with each business application functionality in any software application(s) landscape. Subsequently, any change in the process ontology 206 is adapted with one or more respective software application(s), and vice versa. Details associated with update of the one or more software application(s) are further described in conjunction with, for example, FIG. 6A and FIG. 6B.

FIG. 6A is a diagram that illustrates exemplary operations for controlling execution of the at least one operation based on an update in an application, in accordance with an embodiment of the disclosure. FIG. 6A is explained in conjunction with elements from FIG. 1, FIG. 2, FIG. 3A, FIG. 3B, FIG. 3C, FIG. 4, and FIG. 5. With reference to FIG. 6A, there is shown a diagram 600A that illustrates exemplary operations from 602 to 612, as described herein. The exemplary operations illustrated in the diagram 600A start at 602 and are performed by any computing system, apparatus, or device, such as by the computer 102 of FIG. 1 or the system 202 of FIG. 2. Although illustrated with discrete blocks, the exemplary operations associated with one or more blocks of the diagram 600A are divided into additional blocks, combined into fewer blocks, or eliminated, depending on the particular implementation.

At 602, an application data reception operation is performed. In the application data reception operation, the system 202 is configured to receive application data associated with each application of a plurality of applications 602A. In certain cases, the plurality of applications 602A may correspond to different business application functionalities of the business. The application data for an application may include, but is not limited to, a set of operations associated with the application, correlation information associated with the application, and at least a subset of the plurality of subsets 210 of the hierarchical ontology, dependency information associated with the application and other applications of the plurality of applications 602A, user data associated with the user(s) of the application, configuration data, cache data, logs, and diagnostic data, database records, and metadata.

For example, the plurality of applications 602A are software applications associated with the business. Moreover, the plurality of applications 602A may correspond to different functionalities, modules, or components of a same software application or different software applications. For example, for the warehouse management business, the plurality of applications 602A may be associated with, for example, tracking and maintaining stocks or inventory, receiving orders, payments tracking and execution, quality assurance, and customer service. To this end, the system 202 is configured to retrieve application data associated with each of the plurality of applications 602A.

When a software application is to be developed, then each functionality or application of the software application may be developed individually. Each application may be developed based on specific requirements of concept and metadata associated with the application. In other words, each application is designed and developed based on its own set of specifications and requirements.

For example, the process ontology 206 includes a concept representing ‘customer’ which has associated concepts or metadata associated with, for example, ‘name’, ‘address’, ‘phone number’, ‘email’, and so forth. Based on the concept representing ‘customer’, an application or functionality of the software application may be created for customer data management, such as adding new customers, updating existing customer information, and retrieving customer data. Once all the functionalities or applications relating to the software application are developed and tested individually, they may be integrated to create the complete software application that meets the requirements of the process ontology 206.

For example, the application data may include one or more software instructions set, configuration files, metadata, ontology mapping data, etc. for each of the plurality of applications 602A. The one or more software instructions set, and the configuration files may be written in a corresponding programming language to implement the functionality of an application. Configuration files may indicate settings and parameters for the proper functioning of the application. The metadata may include information associated with the application, such as the purpose of the application, data on which the application operates, expected input and output formats of the application, and any dependencies or constraints for the application to work correctly. The ontology mapping data may indicate a portion of the process ontology 206, such as a subset of the hierarchical structure 208 that is relevant to the application. The subset may include concepts and relationships for the application to operate correctly. For example, for a customer data management application, the one or more software instructions set may implement features, such as adding a new customer, updating customer information, searching for customer details, and deleting customer records. The configuration files for the customer data management application may define settings, such as database connection details, data validation rules, and user access permissions.

At 604, an updated one or more subsets retrieval operation is performed. In the updated one or more subsets reception operation, the system 202 is configured to retrieve updated one or more subsets. A manner in which the one or more subsets of the hierarchical structure 208 is updated is described in conjunction with, for example, FIG. 2, FIG. 3A, FIG. 3B, FIG. 3C, FIG. 4, and FIG. 5. Once the one or more subsets of the hierarchical structure 208 are updated and validated, the updated one or more subsets may be stored as part of the process ontology 206 within the one or more data sources 204 or a database.

At 606, an application identification operation is performed. In the application identification operation, the system 202 is configured to identify at least one application of the plurality of applications 602A associated with at least one subset of the one or more subsets based on the application data and the ontology data. For example, based on the application data and the ontology data, a mapping may be determined between each of the plurality of applications 602A and the plurality of subsets 210. Based on the mapping and the updated one or more subsets, the at least one application mapped to the updated one or more subsets is identified.

For example, the mapping between the plurality of applications 602A and the plurality of subsets 210 may establish relationships between the application and the entities in the process ontology 206. The mapping ensures that the application operates in accordance with certain rules and processes that are defined in the process ontology 206. The mapping may also enable communication and understanding between users of the plurality of applications 602A and developers of the plurality of applications 602, as both parties can refer to the same set of entities and relationships when discussing the plurality of applications 602A.

For example, based on the metadata of each of the plurality of applications 602A, and metadata of each of the plurality of subsets 210 in the hierarchical structure 208, the system 202 is configured to create a one-to-one mapping using a natural language processing (NLP) model. In this regard, the system 202 is configured to implement the NLP model to identify and extract relevant entities, concepts, and relationships from the metadata of the plurality of applications 602A and the plurality of subsets 210. The NLP model may be implemented using processes, such as named entity recognition (NER), dependency parsing, sentiment analysis, tokenization, text classification, topic modeling, or a combination thereof. The created one-to-one mapping between the plurality of applications 602A and the plurality of subsets 210 through NLP may establish clear relationships between each of the plurality of applications 602A and the corresponding relevant subset of the plurality of subsets 210. The mapping may ensure that the plurality of applications 602A is aligned with the hierarchical structure 208 of the process ontology 206.

To this end, the mapping may help developers of the plurality of applications 602A to understand the business context of each of the plurality of applications 602A, and how it fits into the overall process ontology 206. The mapping may also help in maintaining the plurality of applications 602A and making changes or updates in the plurality of applications 602A in a time and resource-efficient manner, as identification of the at least one application mapped to the one or more subsets gets easier.

The system 202 is also configured to identify a manner in which the plurality of applications 602A are interrelated or integrated with each other based on the application data. In this regard, the system 202 is configured to use various processes, such as system architecture diagrams, flowcharts, and sequence diagrams to visualize how different applications are connected to each other and how data flows between them. Based on the visualization of the integration of the plurality of applications 602A, integration points between the plurality of applications 602A are identified. Subsequently, the system 202 may identify potential issues or bottlenecks that may arise during implementation, such as integration of an update in an application of the plurality of applications 602A, addition of an application to plurality of applications 602A, or deletion of an application from the plurality of applications 602A. Based on the visualization of the integration between the plurality of applications 602A, the system 202 is also configured to identify or predict an anomaly in the application and track the anomaly.

At 608, an application data update operation is performed. In the application data update operation, the system 202 is configured to update the application data associated with the identified at least one application. The update of the identified at least one application may be based on the updated one or more subsets of the hierarchical structure 208. Subsequently, updated application data for the identified at least one application may align the at least one application with the change data.

Based on a change in the hierarchical structure 208 of the process ontology 206, hierarchical relationships among the one or more subsets or the one or more sub-ontologies are updated. The system 202 is further configured to integrate the change in the process ontology 206 with impacted application(s) or application functionality(es) of the same software application or different software applications. Such impacted application(s) or the application functionality(es), referred to as the identified at least one application, may be associated with the one or more subsets or the one or more sub-ontologies that have been updated.

For example, the system 202 is configured to analyze the application data of the identified at least one application to identify application requirements, functionalities, implementations, code, and so forth. Thereafter, the application data of the identified at least one application is updated to align the identified at least one application with the updated process ontology 206. In this manner, the system 202 may create one to one relationship between the application functionalities of the at least one application and the one or more subsets of the hierarchical structure 208.

For example, the system 202 is configured to receive data associated with the updated one or more subsets. The data associated with the updated one or more subsets may indicate the change in the process ontology 206. Further, the system 202 is configured to compare the updated one or more subsets with a corresponding previous version of the updated one or more subsets. Based on the comparison, the system 202 is configured to identify the changes made to the one or more subsets. Subsequently, the system 202 is configured to update a mapping between the process ontology 206 corresponding to the one or more subsets and application data, such as application codebase corresponding to the identified at least one application. In addition, the system 202 is configured to maintain a track of version history of the process ontology 206 and the application data to revert to previous versions if needed, or to ensure consistent and up-to-date mapping between the process ontology 206 and the plurality of applications 602A.

For example, the change data is indicative of a merging of the one or more subsets, or a splitting of the one or more subsets. It may be noted that based on the change data, the one or more subsets are updated to generate the updated one or more subsets. In order to reflect the change associated with splitting or merging in the updated one or more subsets, the system 202 is configured to generate integration data associated with the identified at least one application. The integration data is generated based on the updated one or more subsets of the hierarchal structure 208 and the updated application data of the at least one application. The integration data indicates a positive integration of the at least one application, or a negative integration of the at least one application. For example, the positive integration of the at least one application may correspond to the merging of two or more functionalities of the at least one application or the merging of two applications. Further, the negative integration of the at least one application may correspond to splitting of a single functionality into two or more functionalities of the at least one application, or splitting of the at least one application. Further, the system 202 is configured to output the integration data for an update of the at least one application. For example, the integration data may be utilized by the developers of the plurality of applications 602A to update the at least one application. For example, the integration data may indicate a manner in which the updated at least one application needs to be compiled.

At 610, an updated application data output operation is performed. In the updated application data output operation, the system 202 is configured to output the updated application data associated with the at least one application. For example, the updated application data may be validated. Further, the updated application data may be used for downstream tasks, such as compiling or executing updates in the at least one application, raising development tasks for the at least one application, and the like.

At 612, an operation execution control operation is performed. In the operation execution control operation, the system 202 is configured to control the execution of the at least one operation of the set of operations based on the updated application data. For example, the at least one application is updated based on the update of the application data associated with the at least one application. Further, execution of the at least one operation is controlled such that the at least one operation is executed in the updated at least one application.

Similar to identifying a change in the process ontology 206 and updating the at least one application based on the change, the system 202 is also configured to identify a change in the at least one application and update the process ontology 206 based on the change. Details associated with updating the process ontology 206 based on a change in an application are described in conjunction with, for example, FIG. 6B.

Referring to FIG. 6B, exemplary operations for updating one or more subsets of the process ontology 206 is illustrated, in accordance with an embodiment of the disclosure. FIG. 6B is explained in conjunction with elements from FIG. 1, FIG. 2, FIG. 3A, FIG. 3B, FIG. 3C, FIG. 4, FIG. 5, and FIG. 6A. With reference to FIG. 6B, there is shown a diagram 600B that illustrates exemplary operations from 614 to 620, as described herein. The exemplary operations illustrated in the diagram 600B start at 614 and are performed by any computing system, apparatus, or device, such as by the computer 102 of FIG. 1 or the system 202 of FIG. 2. Although illustrated with discrete blocks, the exemplary operations associated with one or more blocks of the diagram 600B are divided into additional blocks, combined into fewer blocks, or eliminated, depending on the particular implementation.

At 614, a requirement data reception operation is performed. In the requirement data reception operation, the system 202 is configured to receive requirement data associated with the at least one application of the plurality of applications 602A. The requirement data include one or more updated characteristics associated with a functionality of the at least one application. For example, the requirement data indicates a change in the application, such as an update in the functionality of the at least one application, an addition, a deletion, or a merging. For example, the requirement data may correspond to an updated version of a program code associated with the at least one application.

At 616, a requirement data analysis operation is performed. In the requirement data analysis operation, the system 202 is configured to analyze the requirement data associated with the at least one application of the plurality of applications 602A. The system 202 is configured to analyze the requirement data to identify a change in the at least one application. The system 202 is configured to analyze the requirement data and identify one or more functionalities associated with the at least one application that have been added, modified, or deleted.

At 618, a one or more subsets identification operation is performed. In the one or more subsets identification operation, the system 202 is configured to identify one or more subsets of the hierarchal structure 208 based on the analysis of the requirement data. For example, the system 202 maintains mapping information indicating one-to-one relationship between each of the plurality of applications 602A and corresponding subsets of the plurality of subsets 210. For example, based on the mapping information, the system 202 is configured to identify the one or more subsets that are associated with the at least one application in which the change is performed.

At 620, a one or more subsets update operation is performed. In the one or more subsets update operation, the system 202 is configured to update the one or more subsets of the hierarchal structure 208 based on the one or more updated characteristics of the requirement data. In this regard, the update of the one or more subsets of the hierarchal structure 208 may align the one or more subsets with the updated at least one application. In addition, a mapping between functionalities of the at least one application and the one or more subsets of the hierarchal structure 208 may be updated. It may be noted that updating the one or more subsets may include updating a piece of the ontology data associated with the one or more subsets. Thereafter, the updated one or more subsets may be validated and/or stored as part of the process ontology 206.

It may be noted that the description of the plurality of applications 602A to correspond to software applications is only exemplary and should not be construed as a limitation. In an alternate example of the present disclosure, the plurality of applications 602A may be associated with tasks or business processes implemented or executed in the physical world, such as by a user, a machine, a robotic entity, or a combination thereof.

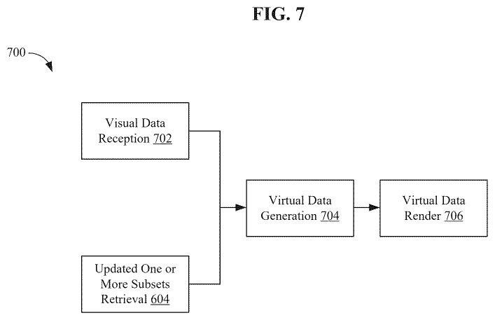

FIG. 7 is a diagram that illustrates exemplary operations for rendering virtual data, in accordance with an embodiment of the disclosure. FIG. 6B is explained in conjunction with elements from FIG. 1, FIG. 2, FIG. 3A, FIG. 3B, FIG. 3C, FIG. 4, FIG. 5, FIG. 6A and FIG. 6B. With reference to FIG. 7, there is shown a diagram 700 that illustrates exemplary operations from 702 to 706, as described herein. The exemplary operations illustrated in the diagram 700 start at 702 and are performed by any computing system, apparatus, or device, such as by the computer 102 of FIG. 1 or the system 202 of FIG. 2. Although illustrated with discrete blocks, the exemplary operations associated with one or more blocks of the diagram 700 are divided into additional blocks, combined into fewer blocks, or eliminated, depending on the particular implementation.

At 702, a visual data reception operation is performed. In the visual data reception operation, the system 202 is configured to receive visual data, such as images and videos associated with the execution of the at least one operation within a virtual environment. For example, the virtual environment corresponds to an augmented reality (AR) environment. In such a case, the at least one operation may be executed in the physical world or in real-life environments, such as using real-world objects. The real-world objects may correspond to a user, a machine, and the like. Further, in the AR environment, virtual reality-based software applications and hardware components, such as AR glasses, may be used to overlay digital content onto the real-world objects. In an alternate example, the virtual environment may correspond to a virtual reality (VR) environment, or mixed reality (MR) environment. Subsequently, the visual data may include VR data associated with the execution of the at least one operation in the VR environment, MR data associated with the execution of the at least one operation in the MR environment, or AR data associated with the execution of the at least on operation in the AR environment.

At 604, an updated one or more subsets retrieval operation is performed. In the updated one or more subsets reception operation, the system 202 is configured to retrieve the updated one or more subsets. Details associated with the updated one or more subsets retrieval operation are described in conjunction with, for example, FIG. 6A.

At 704, a virtual data generation operation is performed. In the virtual data generation, the system 202 is configured to generate virtual data associated with the execution of the at least one operation within the virtual environment. The virtual data is generated based on the visual data associated with the virtual environment and the updated one or more subsets of the hierarchical structure 208. For example, the virtual data may indicate a digital content to be depicted in the virtual environment. The digital content is associated with, but not limited to, textual data, signs or symbols, pictorial data, visualization models, and so forth.

For example, the virtual data is generated based on analyzing a modification or a change associated with the execution of the at least one operation. For example, when the visual data or the operation data indicates the change in the execution of the at least one operation, the virtual data is generated to visualize an updated manner of executing the at least one operation. For example, the virtual data is generated after the updated one or more subsets associated with the at least one operation have been validated. To this end, once the change is confirmed or validated, certain training may be required to inform and update the manner of the execution of the at least one operation by different components in the virtual environment. Subsequently, the virtual data may comprise instructions as textual data, pictorial data, or acoustic data.

At 706, a virtual data render operation is performed. In the virtual data render, the system 202 is configured to render the virtual data on one or more user devices. For example, the one or more user devices may be AR glasses. Further, the virtual data may be rendered in the real-world environment and/or the virtual environment. For example, the virtual data is rendered to assist in the execution of the at least one operation in the virtual environment in an updated manner.

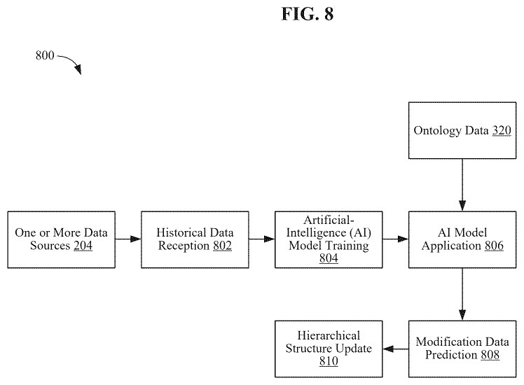

FIG. 8 is a diagram that illustrates exemplary operations for updating the hierarchical structure 208 of the process ontology 206, in accordance with an embodiment of the disclosure. FIG. 8 is explained in conjunction with elements from FIG. 1, FIG. 2, FIG. 3A, FIG. 3B, FIG. 3C, FIG. 4, FIG. 5, FIG. 6A, FIG. 6B and FIG. 7. With reference to FIG. 8, there is shown a diagram 800 that illustrates exemplary operations from 802 to 810, as described herein. The exemplary operations illustrated in the diagram 800 start at 802 and are performed by any computing system, apparatus, or device, such as by the computer 102 of FIG. 1 or the system 202 of FIG. 2. Although illustrated with discrete blocks, the exemplary operations associated with one or more blocks of the diagram 800 are divided into additional blocks, combined into fewer blocks, or eliminated, depending on the particular implementation.

At 802, a historical data reception operation is performed. The historical data is associated with each historical hierarchical structure of a plurality of historical hierarchical structures. Further, each historical hierarchical structure of the plurality of historical hierarchical structures is associated with a historical process ontology. For example, the plurality of historical hierarchical structures may correspond to historical process ontologies relating to the same domains or industries as that of the process ontology 206. For example, the historical process ontologies may be associated with existing businesses operating in the same domain as the business associated with the process ontology 206. For example, the historical data associated with each historical hierarchical structure of the plurality of historical hierarchical structures is received from the one or more data sources 204.

At 804, an artificial intelligence (AI) model training operation is performed. In the AI model training operation, the system 202 is configured to train an AI model based on the historical data. For example, the AI model then analyzes the historical data associated with each historical hierarchical structure of the plurality of historical hierarchical structures to identify patterns and relationships associated with evolution of the historical process ontologies.

Specifically, the AI model is trained to identify one or more change parameters associated with each historical hierarchical structure of the plurality of historical hierarchical structures. In this regard, the AI model is trained to predict changes or modifications in process ontologies that may happen or occur over time. Moreover, the AI model is trained for predicting a time period or a predefined criteria associated with a future change to be made in process ontologies.

In an embodiment of the disclosure, the training of the AI model corresponds to the tuning of one or more hyper-parameters associated with the AI model based on the historical data. In an embodiment of the disclosure, the system 202 adjusts the one or more hyperparameters (the weights and other parameters) of the AI model based on the identified patterns and the identified relationships between in the historical data for prediction of the one or more changes parameters in the historical data.

In an embodiment, the system 202 adjusts the one or more hyper-parameters of each node of the AI model based on whether a predicted output of a final layer of the AI model matches the actual output in the historical data. The system 202 further calculates a loss function or a training error associated with the AI model based on a determination of whether the predicted output matches the actual output or not. The system 202 further repeats the adjustment of one or more hyper-parameters until a minima of the loss function is achieved, or until the training error is minimized.

At 806, an AI model application operation is performed. In the AI model application operation, the system 202 is configured to apply the trained AI model to the hierarchical structure 208 of the process ontology 206. In particular, the trained AI model is applied to the ontology data 320 defining information associated with the hierarchical structure 208 of the process ontology 206. The trained AI model analyzes the ontology data 320 and the hierarchical structure 208 and generates a predicted change for the process ontology 206.

At 808, a modification data prediction operation is performed. In the modification data prediction operation, the system 202 is configured to predict modification data associated with the hierarchical structure 208 over a time period based on the application of the trained AI model. For example, the modification data may indicate a manner in which the hierarchical structure 208 may get updated over the time period. Further, the modification data may indicate various criteria or thresholds associated with different modifications of the hierarchical structure 208.

For example, for the process ontology 206 relating to warehouse management, the AI model may predict modification data associated with the hierarchical structure 208. In such a case, the modification data may indicate, for example, a modification corresponding to a change in product catalogs based on any change in demand and/or supply of different goods or products.

At 810, a hierarchal structure update operation is performed. In the hierarchal structure update operation, the system 202 is configured to update the hierarchical structure 208 over the time period based on the modification data. For example, when the system 202 identifies that a predicted threshold or condition associated with a predicted modification is met, then the system 202 is configured to initiate update of the hierarchical structure 208 based on the predicted modification. A manner in which the system 202 is configured to update the hierarchical structure 208 is described in detail in conjunction with, for example, FIG. 2, FIG. 3A, FIG. 3B, FIG. 3C, FIG. 4, FIG. 5, FIG. 6A, FIG. 6B, and FIG. 7.

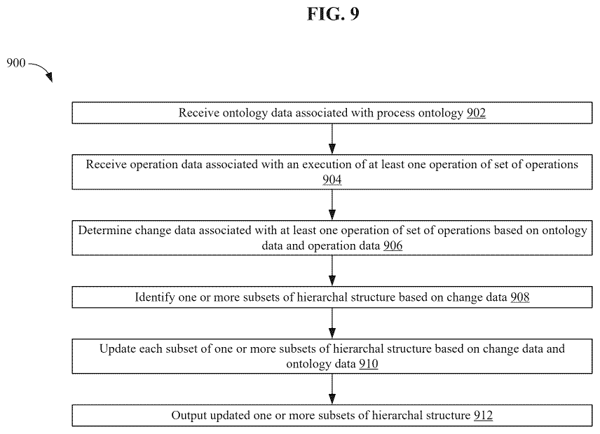

FIG. 9 is a diagram that is a that illustrates a flowchart for an exemplary method for updating the subsets of the process ontology 206, in accordance with an embodiment of the disclosure. FIG. 9 is explained in conjunction with elements from FIG. 1, FIG. 2, FIG. 3A, FIG. 3B, FIG. 3C, FIG. 4, FIG. 5, FIG. 6A, FIG. 6B, FIG. 7, FIG. 8 and FIG. 9. With reference to FIG. 9, there is shown a flowchart 900. The operations of the exemplary method are executed by any computing system, for example, by the computer 102 of FIG. 1 or the system 202 of FIG. 2. The operations of the flowchart 900 may start at 902.

At 902, ontology data associated with a process ontology is received. In an embodiment, the system 202 is configured to receive the ontology data associated with the process ontology 206. The process ontology 206 includes the hierarchal structure 208 of a plurality of entities. The ontology data indicates a set of operations associated with each entity of one or more entities of the plurality of entities.

At 904, operation data associated with an execution of at least one operation of the set of operations is received. In an embodiment, the system 202 is configured to receive the operation data associated with the execution of the at least one operation of the set of operations.

At 906, change data associated with the at least one operation of the set of operations is determined. In an embodiment, the system 202 is configured to determine the change data associated with the at least one operation of the set of operations based on the ontology data and the operation data.

At 908, one or more subsets of the hierarchical structure are identified. In an embodiment, the system 202 is configured to identify the one or more subsets of the hierarchical structure 208 based on the change data. The one or more subsets include a first subset associated with the at least one operation and at least one second subset associated with the first subset.

At 910, each subset of the one or more subsets of the hierarchal structure 208 is updated. In an embodiment, the system 202 is configured to update each subset of the one or more subsets of the hierarchal structure 208 based on the change data and the ontology data.

At 912, the updated one or more subsets of the hierarchal structure 208 are output. In an embodiment, the system 202 is configured to output the updated one or more subsets of the hierarchal structure 208.

While the above steps shown in FIG. 9 are described in a particular sequence, the steps may occur in variations to the sequence in accordance with various embodiments of the present disclosure. Further, details related to various steps of FIG. 9, which are already covered in the description related to FIG. 1 to FIG. 8, are not discussed again in detail here for the sake of brevity.

Various embodiments of the disclosure may provide a computer-program product for updating subsets of process ontology. The computer-program product includes one or more computer-readable storage media and program instructions stored on the one or more computer-readable storage media to perform operations including receiving ontology data associated with the process ontology 206. The process ontology 206 includes the hierarchal structure 208 of the plurality of entities. The ontology data indicates a set of operations associated with each entity of one or more entities of the plurality of entities. The operations further include receiving operation data associated with an execution of at least one operation of the set of operations. The operations further include determining change data associated with the at least one operation of the set of operations based on the ontology data and the operation data. The operations further include identifying the one or more subsets 210 of the hierarchal structure 208 based on the change data. The one or more subsets 210 include a first subset associated with the at least one operation and at least one second subset associated with the first subset. The operations further include updating each subset of the one or more subsets 210 of the hierarchal structure 208 based on the change data and the ontology data. Further, the operations include outputting the updated one or more subsets 210 of the hierarchal structure 208.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, ontology data associated with a process ontology, wherein the process ontology comprises a hierarchal structure of a plurality of entities, and wherein the ontology data indicates a set of operations associated with each entity of one or more entities of the plurality of entities;
receiving, by the computer, operation data associated with an execution of at least one operation of the set of operations;
determining, by the computer, change data associated with the at least one operation of the set of operations based on the ontology data and the operation data;
identifying, by the computer, one or more subsets of the hierarchal structure based on the change data, wherein the one or more subsets comprise a first subset associated with the at least one operation and at least one second subset associated with the first subset;
updating, by the computer, each subset of the one or more subsets of the hierarchal structure based on the change data and the ontology data; and
outputting, by the computer, the updated one or more subsets of the hierarchal structure.

2. The computer-implemented method of claim 1, further comprising:
receiving, by the computer, application data associated with each application of a plurality of applications;
identifying, by the computer, at least one application of the plurality of applications associated with at least one subset of the one or more subsets based on the application data and the ontology data;
updating, by the computer, the application data associated with the at least one application of the plurality of applications based on the updated one or more subsets of the hierarchal structure;
outputting, by the computer, the updated application data associated with the at least one application; and
controlling, by the computer, the execution of the at least one operation of the set of operations, wherein the execution is based on the updated application data.

3. The computer-implemented method of claim 2, wherein the change data is indicative of at least one of a merging of the one or more subsets, or a splitting of the one or more subsets, the method further comprising:
generating, by the computer, integration data associated with the at least one application based on the updated one or more subsets of the hierarchal structure and the updated application data, wherein the integration data indicates at least one of a positive integration of the at least one application, or a negative integration of the at least one application; and
outputting, by the computer, the integration data for an update of the at least one application.

4. The computer-implemented method of claim 3, further comprising:
receiving, by the computer, requirement data associated with the at least one application of the plurality of applications, wherein the requirement data comprises one or more updated characteristics associated with a functionality of the at least one application;
identifying, by the computer, the one or more subsets of the hierarchal structure based on the requirement data; and
updating, by the computer, each subset of the identified one or more subsets of the hierarchal structure based on the one or more updated characteristics.

5. The computer-implemented method of claim 1, wherein the operation data comprises visual data associated with the execution of the at least one operation within a virtual environment, and wherein the visual data comprises at least one of augmented reality (AR) data, mixed reality (MR) data, or virtual reality (VR) data.

6. The computer-implemented method of claim 5, further comprising:
generating, by the computer, virtual data associated with the execution of the at least one operation within the virtual environment, wherein the virtual data is generated based on the visual data associated with the virtual environment and the updated one or more subsets of the hierarchical structure; and
rendering, by the computer, the virtual data on one or more user devices.

7. The computer-implemented method of claim 1, further comprising:
determining, by the computer, relationship data associated with the hierarchical structure based on the ontology data, wherein the relationship data indicates a plurality of links, and wherein each link of the plurality of links defines a relationship between two entities of the plurality of entities; and
determining, by the computer, a plurality of subsets associated with the hierarchical structure of the process ontology based on the relationship data, wherein
the plurality of subsets comprises the one or more subsets,
each subset of the plurality of subsets comprises at least one entity of the plurality of entities, and
the at least one entity of each subset of the plurality of subsets defines at least one of a specific domain or a specific function within the process ontology.

8. The computer-implemented method of claim 7, further comprising:
determining, by the computer, a subset of the relationship data associated with each subset of the one or more subsets based on the relationship data, wherein the subset of the relationship data indicates an interdependency between the first subset and the at least one second subset;
updating, by the computer, the subset of the relationship data based on the change data; and
updating, by the computer, each subset of the one or more subsets of the hierarchal structure based on the updated subset of the relationship data.

9. The computer-implemented method of claim 1, wherein the process ontology is a business ontology, wherein each subset of the one or more subsets is associated with a sub-ontology of the business ontology, and wherein the sub-ontology is associated with a business application function.

10. The computer-implemented method of claim 1, wherein the operation data indicates an anomaly associated with the execution of the at least one operation, and wherein the method further comprises:
generating, by the computer, notification data associated with the updated one or more subsets of the hierarchal structure; and
transmitting, by the computer, the notification data to one or more user devices associated with the hierarchical structure of the updated one or more subsets.

11. The computer-implemented method of claim 1, further comprising:
receiving, by the computer, historical data associated with each historical hierarchical structure of a plurality of historical hierarchical structures, wherein each historical hierarchical structure of the plurality of historical hierarchical structures is associated with a historical process ontology;
training, by the computer, an artificial intelligence (AI) model based on the historical data, wherein the AI model is trained to identify one or more change parameters associated with each historical hierarchical structure of the plurality of historical hierarchical structures;
applying, by the computer, the trained AI model to the hierarchical structure of the process ontology;
predicting, by the computer, modification data associated with the hierarchical structure over a time period based on the application of the trained AI model; and
updating, by the computer, the hierarchal structure over the time period based on the modification data.

12. A computer system, comprising:
a processor set;
one or more computer-readable storage media; and
program instructions stored on the one or more computer-readable storage media, the program instructions executable by the processor set to cause the processor set to:
receive ontology data associated with a business ontology, wherein the business ontology comprises a hierarchal structure of a plurality of domains, and wherein the ontology data indicates a set of operations associated with each domain of one or more domains of the plurality of domains;
receive update data associated with an execution of at least one operation of the set of operations;
generate operation data associated with the execution of the at least one operation of the set of operations, wherein the operation data is generated based on the update data;
determine change data associated with the at least one operation of the set of operations based on the ontology data and the operation data;
identify one or more sub-ontologies of the business ontology within the hierarchical structure based on the change data, wherein the one or more sub-ontologies comprise a first sub-ontology associated with the at least one operation and at least one second sub-ontology associated with the first sub-ontology;
update each sub-ontology of the one or more sub-ontologies within the hierarchal structure based on the change data and the ontology data; and
output the updated one or more sub-ontologies within the hierarchal structure.

13. The computer system of claim 12, wherein the program instructions further cause the processor set to:
receive application data associated with each application of a plurality of applications;
identify at least one application of the plurality of applications associated with at least one sub-ontology of the one or more sub-ontologies based on the application data and the ontology data;
update the application data associated with the at least one application of the plurality of applications based on the updated one or more sub-ontologies within the hierarchal structure;
output the updated application data associated with the at least one application; and
control the execution of the at least one operation of the set of operations, wherein the execution is based on the updated application data.

14. The computer system of claim 13, wherein the change data is indicative of at least one of a merge of the one or more sub-ontologies, or a split of the one or more sub-ontologies, and wherein the program instructions further cause the processor set to:
generate integration data associated with the at least one application based on the updated one or more sub-ontologies and the updated application data, wherein the integration data indicates at least one of a positive integration of the at least one application, or a negative integration of the at least one application; and
output the integration data to trigger the update of the at least one application.

15. The computer system of claim 14, wherein the program instructions further cause the processor set to:
receive requirement data associated with the at least one application of the plurality of applications, wherein the requirement data comprises one or more updated characteristics associated with a functionality of the at least one application;
identify the one or more sub-ontologies within the hierarchal structure based on the requirement data; and
update each sub-ontology of the identified one or more sub-ontologies within the hierarchal structure based on the one or more updated characteristics.

16. The computer system of claim 13, wherein the update data is received as part of at least one of user input data, visual data, or the application data associated with the at least one application.

17. The computer system of claim 12, wherein the program instructions further cause the processor set to:
determine relationship data associated with the hierarchical structure based on the ontology data, wherein the relationship data indicates a plurality of links, and wherein each link of the plurality of links defines a relationship between two domains of the plurality of domains; and
determine a plurality of sub-ontologies associated with the hierarchical structure of the business ontology based on the relationship data, the plurality of sub-ontologies comprising the one or more sub-ontologies, wherein each sub-ontology of the plurality of sub-ontologies comprises at least one domain of the plurality of domains, and wherein the at least one domain of each sub-ontology of the plurality of sub-ontologies defines at least a specific function within the business ontology.

18. The computer system of claim 17, wherein the program instructions further cause the processor set to:
determine sub-ontology relationship data associated with each sub-ontology of the one or more sub-ontologies based on the relationship data, wherein the sub-ontology relationship data indicates an interdependency between the first sub-ontology and the at least one second sub-ontology;
update the sub-ontology relationship data based on the change data; and
update each sub-ontology of the one or more sub-ontologies of the hierarchal structure based on the updated sub-ontology relationship data.

19. The computer system of claim 12, wherein the operation data indicates an anomaly associated with the execution of the at least one operation, and wherein the program instructions further cause the processor set to:
generate notification data associated with the updated one or more sub-ontologies of the hierarchal structure; and
transmit the notification data to one or more user devices associated with the hierarchical structure of the updated one or more sub-ontologies.

20. A computer-program product for updating one or more subsets of a process ontology, the computer-program product comprising:
one or more computer-readable storage media; and
program instructions stored on the one or more computer-readable storage media to perform operations comprising:
receiving ontology data associated with the process ontology, wherein the process ontology comprises a hierarchal structure of a plurality of entities, and wherein the ontology data indicates a set of operations associated with each entity of one or more entities of the plurality of entities;
receiving operation data associated with an execution of at least one operation of the set of operations;
determining change data associated with the at least one operation of the set of operations based on the ontology data and the operation data;
identifying the one or more subsets of the hierarchal structure based on the change data, wherein the one or more subsets comprise a first subset associated with the at least one operation and at least one second subset associated with the first subset;
updating each subset of the one or more subsets of the hierarchal structure based on the change data and the ontology data; and
outputting the updated one or more subsets of the hierarchal structure.
